(19) United States
(12) Patent Application Publication
(10) Pub. No.: US 2017/0132570 A1
(43) Pub. Date: May 11, 2017

(54) Computer-Implemented Method For Evaluating Suitability Of An Applicant For A Team And A System Thereof

(71) Applicant: Raymond Seetoh, Singapore (SG)

(72) Inventor: Raymond Seetoh, Singapore (SG)

(21) Appl. No.: 15/147,074

(22) Filed: May 5, 2016

(30) Foreign Application Priority Data
Nov. 11, 2015 (SG) 10201509288P

(51) Int. Cl. G06Q 10/10; G06F 17/30

(52) U.S. Cl. CPC G06Q 10/1053; G06F 17/3053

(57) ABSTRACT

A computer-implemented method for evaluating the suitability of an applicant for a team having at least one team member, the method includes generating a team reference data based on at least one team member reference response, each from a team member's reference provider, such that the team member reference response includes a response to a plurality of questions relevant to the at least one team member; receiving an applicant reference response from at least one reference provider, such that the applicant reference response includes a response from the at least one reference provider to a plurality of questions relevant to the applicant; generating an applicant reference data based on at least one of the applicant reference response; and generating a suitability score based on the applicant reference data and the team reference data, such that the suitability score indicates the suitability of the applicant for the team.

### FIELD OF THE INVENTION

The present invention relates to a computer-implemented method for evaluating suitability of an applicant for a team and a system thereof.

### BACKGROUND OF THE INVENTION

Recruitment of a team member can be resource and time consuming. During a recruitment process, the recruiter would typically conduct rounds of interviews for many candidates. Despite that, such interviews may not be sufficient to evaluate the candidate as the recruiter would not have spent enough time with the candidate to know the candidate well. While the academic record of the candidate can be known from documents provided by the candidate, it is not easy for a recruiter to know the character of the candidate from the records, much less evaluate how the candidate is suitable for the organisation or team culture.

In the event that a candidate does not fit the team or organization culture after being hired, a team or organisation would usually hesitate to ask the candidate to leave unless there is a valid reason to do so. Therefore, the team or organization would have to work with a team member that is not suitable for the team or organization. Therefore, it is important to have the right team from the beginning as this would reduce work friction within the team or organization.

There are tools that help recruiters seek references from reference providers about the candidates. However, such tools do not provide any help for the recruiters to evaluate if a candidate is suitable for the team or organization.

It is therefore necessary and beneficial to have a system and method to overcome the issues mentioned above and to allow the recruiter evaluate the suitability of a candidate for the team or organization.

### BRIEF SUMMARY OF THE INVENTION

According to various embodiments, the present invention provides a computer-implemented method for evaluating the suitability of an applicant for a team having at least one team member, the method includes generating a team reference data of the team based on at least one team member reference response, each from a team member's reference provider, such that the team member reference response includes a response to a plurality of questions relevant to the at least one team member; receiving an applicant reference response from at least one reference provider, such that the applicant reference response includes a response from the at least one reference provider to a plurality of questions relevant to the applicant; generating an applicant reference data based on at least one of the applicant reference response; and generating a suitability score based on the applicant reference data and the team reference data, such that the suitability score indicates the suitability of the applicant for the team.

According to various embodiments, the method may further include generating a team member reference data for each of the at least one team member based on one or more team member reference response, such that the team reference data is generated based on one or more team member reference data.

According to various embodiments, the method may further include normalising one or more team member reference data.

According to various embodiments, the method may further include normalising the at least one applicant reference data.

According to various embodiments, the applicant reference response may include an array of applicant response data, such that the applicant reference data may include an array of normalised scores which corresponds to the array of applicant response data.

According to various embodiments, the team member reference response includes an array of team member response data, such that the team reference data may include an array of normalised scores which corresponds to the array of team member response data.

According to various embodiments, the method may further include matching the applicant reference data to the team reference data to generate a matching score, such that the matching score indicates the degree of match between the applicant reference data and the team reference data.

According to various embodiments, the method may further include computing a team convergence score based on the team reference data, such that the team convergence score indicates a similarity level between team members in the team.

According to various embodiments, the questions may include selected questions relevant to the team.

According to various embodiments, the plurality of questions may include at least one ipsative question.

According to various embodiments, the present invention provides a computer system for evaluating the suitability of an applicant for a team having at least one team member, the system includes a server configured to generate a team reference data based on at least one team member reference response, each from a team member's reference provider, such that the team member reference response includes a response to a plurality of questions relevant to the at least one team member; receive an applicant reference response from at least one reference provider, such that the applicant reference response includes a response from the at least one reference provider to a plurality of questions relevant to the applicant; generate an applicant reference data based on at least one of the applicant reference response; and generate a suitability score based on the applicant reference data and the team reference data, such that the suitability score indicates the suitability of the applicant for the team.

According to various embodiments, the server may be configured to generate a team member reference data for each of the at least one team member based on one or more team member reference response, such that the team reference data is generated based on one or more team member reference data.

According to various embodiments, the system may further include a team member reference normalising module configured to normalise the one or more team member reference data.

According to various embodiments, the system may further include an applicant reference normalising module configured to normalise the at least one applicant reference data.

According to various embodiments, the applicant reference response may include an array of applicant response data, such that the applicant reference data may include an array of normalised scores which corresponds to the array of applicant response data.

According to various embodiments, the team member reference response may include an array of team member response data, such that the team reference data may include an array of normalised scores which corresponds to the array of team member response data.

According to various embodiments, the system may further include a matching module configured to match the applicant reference data to the team reference data to generate a matching score, such that the matching score indicates the degree of match between the applicant reference data and the team reference data.

According to various embodiments, the system may further include a computing module configured to compute a team convergence score based on the team reference data, such that the team convergence score indicates a similarity level between team members in the team.

According to various embodiments, the questions may include selected questions relevant to the team.

According to various embodiments, the plurality of questions may include at least one ipsative question.

The present invention has the benefit of allowing the recruiter evaluate the suitability of the applicant for the team based on third or independent parties' assessment of the applicant and the team. In addition, the present invention allows the recruiter to obtain reference data based on more than one reference responses thereby ensuring a more robust assessment of the applicant and the team. The present invention provides a normalised reference response so that the reference response received for the applicant or team member can be compared on the same basis and future reference response may be compared with the current reference response on the same basis. The present invention also provides the recruiter the ability to know the degree of match between the applicant reference data and the team reference data to enable the recruiter to have a better understanding on the similarity or difference between both data. The present invention allows the recruiter to find out the level of similarity between team members, or suitability between team members, from the team convergence score. Also, the present invention provides the recruiter the ability to customise a set of the plurality of questions for a specific nature of a team so that each set of plurality of questions can be selected depending on the nature of the team. The present invention allows the recruiter to obtain a more truthful reference response as the reference provider would not be able to consciously choose an answer to best suit an ipsative question.

The present invention provides organizations the ability to assess whether an applicant, or a prospective employee, is a good fit to the organizational culture, or the team. The right hire can add more value to the organization. By making the right decision from the start, organizations can avoid the time delay and associated costs (search costs, training costs, and orientation costs). The present invention uses responses from reference providers or referee to form a profile of an applicant or a team. In this way, the recruiter is able to obtain a more accurate profile of the applicant from the people who know and interact with the candidate. The present invention makes it easy and efficient for a recruiter to collect reference responses as it automates the reference checking process, and relieves human resource personnel to have more time to handle other human resource duties. The present invention frees recruiters from making time-consuming, tiring calls to reference providers. Recruiters can avoid the embarrassment of cold-calling strangers for reference provider checks and may also result in faster response time from reference providers, by tapping on applicants' familiarity with the reference providers to solicit responses. Given the ease of obtaining reference response, the recruiters can deploy a double-stage reference checking process, which is to initiate the automated reference check using the present invention near the start of the recruitment process, to eliminate unsuitable applicants before the interview. The recruiter can then follow up with a manual reference check on selected applicants after the interview, to find out further information. The double-stage reference checking process can eliminate time wastage on interviewing unsuitable applicants, as well as provide more accuracy in selecting the right applicants.

Another advantage of present invention is that the recruiter may be able to control the scope of responses provided by reference providers. Instead of receiving polite, diplomatic, but overly general reference feedback, the present invention enables the recruiter to pose specific questions to reference providers. For example, to limit reference responses to only one out of three specific answers so that the recruiter can get the information that they want. The present invention provides the recruiter a comparison between reference responses of different team members on the same basis, and as well as between applicants and the team. This is because the present invention uses a common reference form for the team, and limited reference answers to the three specific choices. For large organizations, it is time and resource consuming to process an overwhelming quantity of information from a large number of team members. The present invention enables more objective comparison across a large number of references, and across a large number of team members on a common basis. The present invention allows the recruiter to analyse the unity of their team configurations. Further, the present invention allows the recruiter to compile various reference responses into one consolidated report on what reference providers would say about the applicant, compute the cohesiveness of the team, and calculate the suitability level of the applicant with the team. The present invention allows the recruiter to eliminate unsuitable applicants which enable the recruiter to know that the shortlisted applicants have passed his reference checks before the recruiter spends time to interview them.

Recruiter may benefit from using the present invention to build their core leadership team, or to build operational teams further down the hierarchy. Organizations are made of people. The present invention provides organizations the ability to arrange their people into the right teams. By placing people into the right teams, organizations can maximize the potential of each employee and each team. When team members share common values, common objectives, the team may become more effective, more efficient. Having more effective and more efficient teams can mean greater results in less time. On the other hand, when organizations require a team with diverse opinions, different values, the present invention may be used to create such a team. When organizations fit employees who hold the same values into the same teams, it may reduce friction amongst employees. When organizations have happy employees, who bond well together, they reduce employee turnover. This means that organizations can reduce the amount of time and costs associated with searching for new applicants, training new applicants, and orientating new applicants to the organization's culture.

### BRIEF DESCRIPTION OF THE DRAWINGS

FIG. 1 shows an exemplary flow diagram of a method for evaluating suitability of an applicant for a team.

FIG. 2a shows an exemplary embodiment of a computer network for the method in FIG. 1.

FIG. 2b shows an exemplary embodiment of the computer system for the method of FIG. 1.

FIG. 3 shows an exemplary flow diagram of the method in FIG. 1.

FIG. 4a shows an exemplary flow diagram of a process carried out by a question module.

FIG. 4b shows an exemplary flow diagram of additional steps of the question module in FIG. 4a.

FIG. 5 shows an exemplary embodiment of a question user interface.

FIG. 6a shows an exemplary flow diagram of a process carried out by a reference form module.

FIG. 6b shows an exemplary flow diagram of additional steps of the process carried out by the reference form module in FIG. 6a.

FIG. 7 shows an exemplary embodiment of a create-reference-form user interface.

FIGS. 8a and 8b show an exemplary embodiment of the plurality of questions in a reference form.

FIG. 9 shows an exemplary embodiment of a recruiter user interface.

FIG. 10 shows an exemplary example of an applicant user interface.

FIG. 11 shows an exemplary flow diagram of a process carried out by a team module.

FIG. 12a shows an exemplary embodiment of a team display interface.

FIG. 12b shows an exemplary embodiment of a team user interface.

FIG. 13 shows an exemplary flow diagram of a process carried out by a join module.

FIG. 14 shows an exemplary embodiment of a join notification.

FIG. 15a shows an exemplary flow diagram of a process carried out by a project module.

FIG. 15b shows an exemplary flow diagram of additional steps of the process carried out by the project module.

FIG. 16 shows an exemplary embodiment of a project user interface.

FIG. 17 shows an exemplary flow diagram of a process carried out by a reference module.

FIG. 17a shows an exemplary embodiment of an activation notification.

FIG. 18 shows an exemplary flow diagram of a process carried out by a reference response module.

FIGS. 19a and 19b show an exemplary embodiment of an online reference form.

FIG. 20 shows an exemplary flow diagram of a process carried out by a compute module.

FIG. 21 shows an exemplary embodiment a suitability score report.

FIG. 22 shows an exemplary flow diagram of a process carried out by a compute program.

FIGS. 23a and 23b show an exemplary embodiment of the plurality of questions in the reference form.

### DETAILED DESCRIPTION OF THE INVENTION

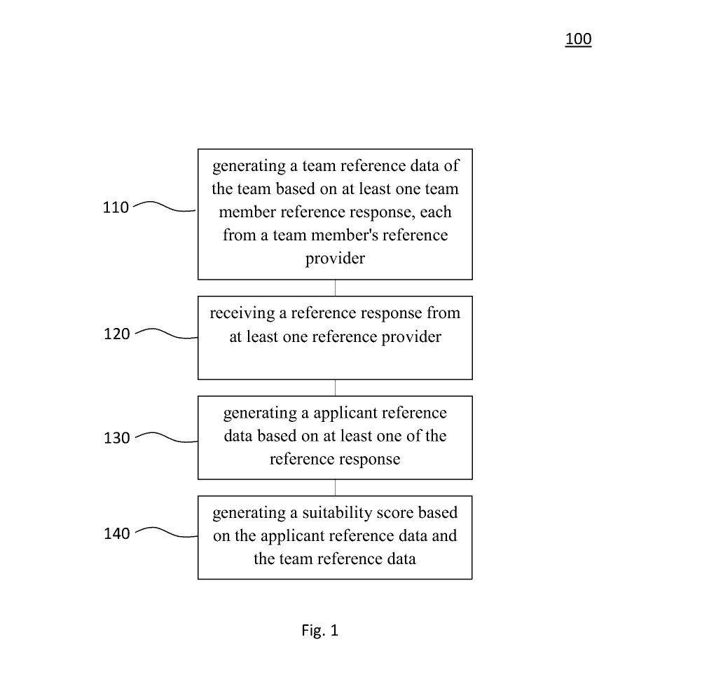

FIG. 1 shows an exemplary embodiment of a flow diagram of a method 100 of evaluating the suitability of an applicant for a team. Method 100 includes generating a team reference data of the team based on at least one team member reference response, each from a team member's reference provider, such that the team member reference response includes a response to a plurality of questions relevant to the at least one team member. Method 100 includes receiving an applicant reference response from at least one reference provider, such that the applicant reference response includes a response from the at least one reference provider to a plurality of questions relevant to the applicant in 120, generating an applicant reference data based on at least one of the applicant reference response in 130; and, in 140, generating a suitability score based on the applicant reference data and the team reference data, the suitability score indicates the suitability of the applicant for the team.

Method 100 may be configured to evaluate the suitability of an applicant for a team. A team may include a group of team members in an organization or for a project. Team may be any group of team members. For example, the team may include a company, a department, a project group, a section. A team may be formed within another team. For example, the recruiter may wish to evaluate the suitability of an applicant for a new position in the company. In another example, a head of department may wish to evaluate the suitability of an employee for a project team. An applicant may be a person who wishes to join a team. Applicant may be a job candidate, a team member, a consultant, a contractor, etc. A reference provider may be a person who is associated with the applicant and provides a reference for the applicant. Reference provider may include a director, a human resource personnel, a superior, a colleague, a customer or a peer of the applicant. A recruiter who wishes to evaluate whether an applicant is suitable for a team may utilise the method 100 to do so. Recruiter may include a job agent, a director, a manager, a team leader, a project leader, human resource manager, etc.

A reference form may be configured to extract the reference provider's response to the applicant's attributes, e.g. character, capability. Reference form may include a plurality of questions relating to the applicant. For example, the plurality of questions may be related to the work performance, competency, character, behaviour, habits of the applicant. Reference form may be a survey form, a questionnaire, etc. Reference form may be in a digital or physical form.

A reference response may be a response from the reference provider to the reference form. Reference response may include answers related to the competency of the applicant and/or character of the applicant. A team member reference response may include a reference response for a team member. An applicant reference response may include a reference response for an applicant. Applicant reference response may include an array of applicant response data, such that the applicant reference data may include an array of normalised scores which corresponds to the array of applicant response data. Team member reference response may include an array of team member response data, such that the team reference data may include an array of normalised scores which corresponds to the array of team member response data.

Team reference data may be generated from at least one team member reference data. Team reference data may be generated based on a plurality of team member reference data of a plurality of team members. Team reference data may include an array of normalised scores corresponding to the team member reference data. Team reference data may be a score, an array of scores, a matrix of scores, etc.

Team member reference data may include a reference provider's response to a team member's reference form. Team member reference data represents the response from a reference provider of a team member to the plurality of questions in the reference form transmitted to the reference provider. A recruiter may wish to obtain the team member reference data for the purpose of obtaining the team reference data so that the recruiter would be able to use the team reference data to evaluate the suitability of the applicant for the team. Team member may include a member of the team. Team member may be an employee, a consultant, a director, a trainee, vendor, contractor, etc. Team member reference data may be a score, an array of scores, a matrix of scores, etc.

Applicant reference data may include the applicant's reference provider's response to the reference form. Applicant reference data may be generated from at least one reference response. Applicant reference data may be generated based on a plurality of reference response. Applicant reference data may include an array of normalised scores corresponding to the reference response. Applicant reference data may be a score, an array of scores, a matrix of scores, etc.

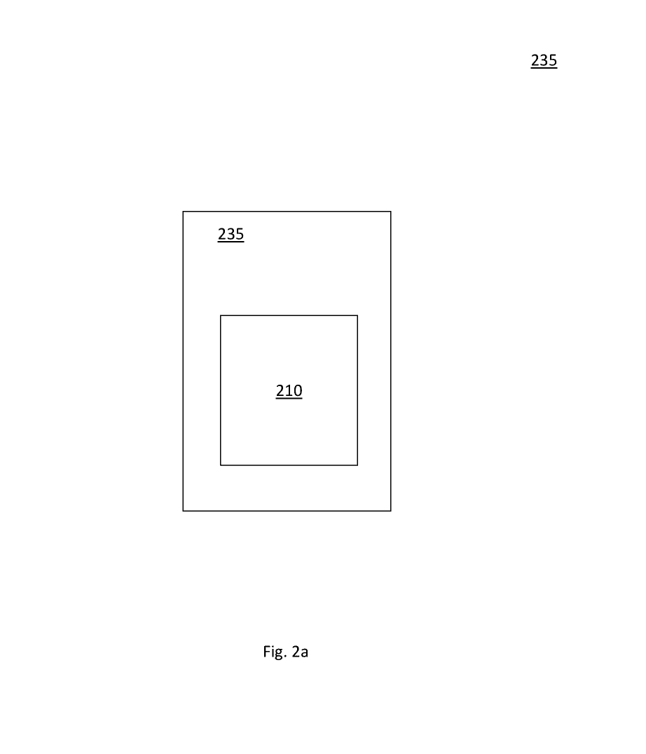

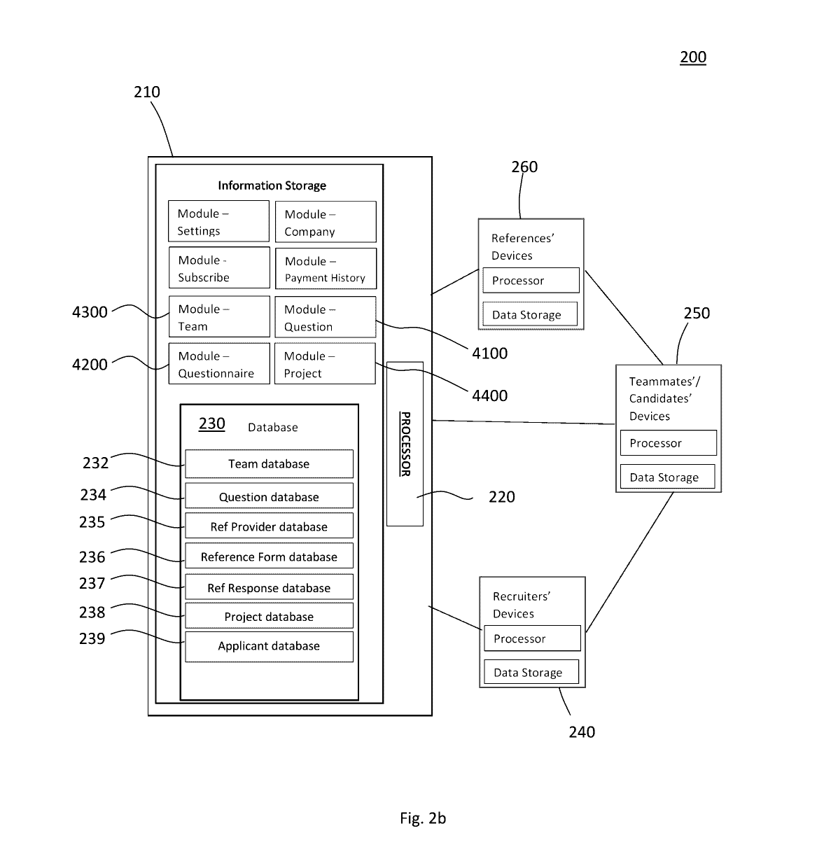

FIG. 2a shows a computer system 235 for evaluating the suitability of an applicant for a team having at least one team member. System 250 includes a server 210. Server 210 is configured to generate a team reference data based on at least one team member reference response, each from a team member's reference provider, such that the team member reference response includes a response to a plurality of questions relevant to the at least one team member, receive an applicant reference response from at least one reference provider, such that the applicant reference response includes a response from the at least one reference provider to a plurality of questions relevant to the applicant, generate an applicant reference data based on at least one of the applicant reference response; and generate a suitability score based on the applicant reference data and the team reference data, such that the suitability score indicates the suitability of the applicant for the team. Server 210 may retrieve the team member reference response over a network.

FIG. 2b shows a computer network 200 configured to implement the method 100. Computer network 200 may include a server 210. Server 210 may include a desktop computer. Server 210 may include a program storage configured to store a plurality of modules configured to implement the method 100, a processor 220, a data storage 230 configured to store a plurality of databases. Server 210 may be connected to a recruiter's device 240, an applicant's device 250, and a reference provider's device 260. Devices 240, 250, 260 may include mobile phone, desktop computers, laptop computers, tablet, etc. Each of the devices 240, 250, 260 may include a processor and a data storage. Devices 240, 250, 260 may include a device display configured to display user interfaces transmitted by the server 210. Server 210 and the devices 240, 250, 260 may be connected to each other wirelessly or wiredly via, e.g. Local Area Network (LAN), Wide Area Network (WAN). A network may include broadband network, mobile network, WIFI, etc. Data storage 230 may include a team database 232. Data storage 230 may include a question database 234, a reference provider database 235, a reference form database 236, a reference response database 237, a project database 238 and an applicant database 239. Data storage may include an applicant database 239 having an applicant reference database. Applicant database 239 may include the reference provider database 235. Server 210 may include a team reference database configured to store at least one team reference data of a team. Server 210 may include a team member reference database configured to store at least one team member reference data of a team member. Method 100 may be implemented by the server 210.

To evaluate the suitability of the applicant, the server may retrieve one or more of the team member reference response from the reference response database and generate the team reference data based on the one or more team member reference response. Server 210 may retrieve the applicant reference data from the applicant reference database. Recruiter may receive the applicant reference response from at least one reference provider. Recruiter may receive a plurality of applicant reference response from a plurality of reference providers. Recruiter may receive the applicant reference response via the server 210. Server 210 may be configured to receive the applicant reference response from the reference provider. Server 210 may include a reference data generation module configured to generate the team reference data from at least one team member reference data. Based on the applicant reference response/s, the server 210 may generate the applicant reference data. Based on the applicant reference data and the team reference data, the recruiter may generate a suitability score to evaluate the suitability of the applicant for the team. Server 210 may be configured to generate the team member reference data based on the team member reference response first before generating the team reference data based on the team member reference data. Server 210 may store the team reference data in the team reference database. Server 210 may store the team member reference data in the team member reference database.

Server 210 may include a reference provider activation module. Reference provider activation module may be configured to authenticate and activate the reference provider for the purpose of evaluating suitability of the applicant.

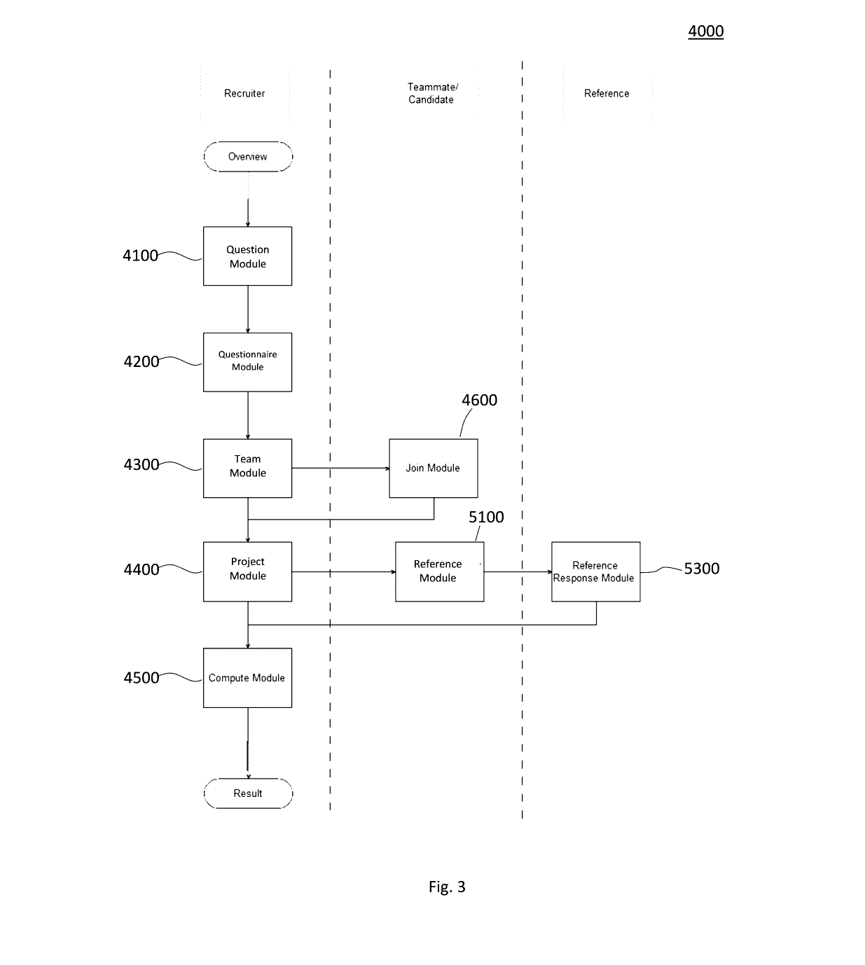

FIG. 3 shows an exemplary flow diagram 4000 of the method 100. Referring to FIG. 3, the server 210 may include a question module 4100 configured to manage the plurality of questions for the reference form, a reference form module 4200 configured to manage the reference form, a team module 4300 configured to manage data of the team, a project module 4400 configured to manage a project, and a compute module 4500 configured to compute the suitability score. Modules 4100-4500 are generally suitable for the recruiter for evaluating the suitability score. Server 210 may further include a join module 4600 configured to manage the joining of the applicant to the team for the evaluation and a reference module 5100. Modules 4600, 5100 are generally suitable for the applicant to communicate with the server 210 and reference provider. Server 210 may further include a reference response module 5300 configured to manage the reference response from the reference provider.

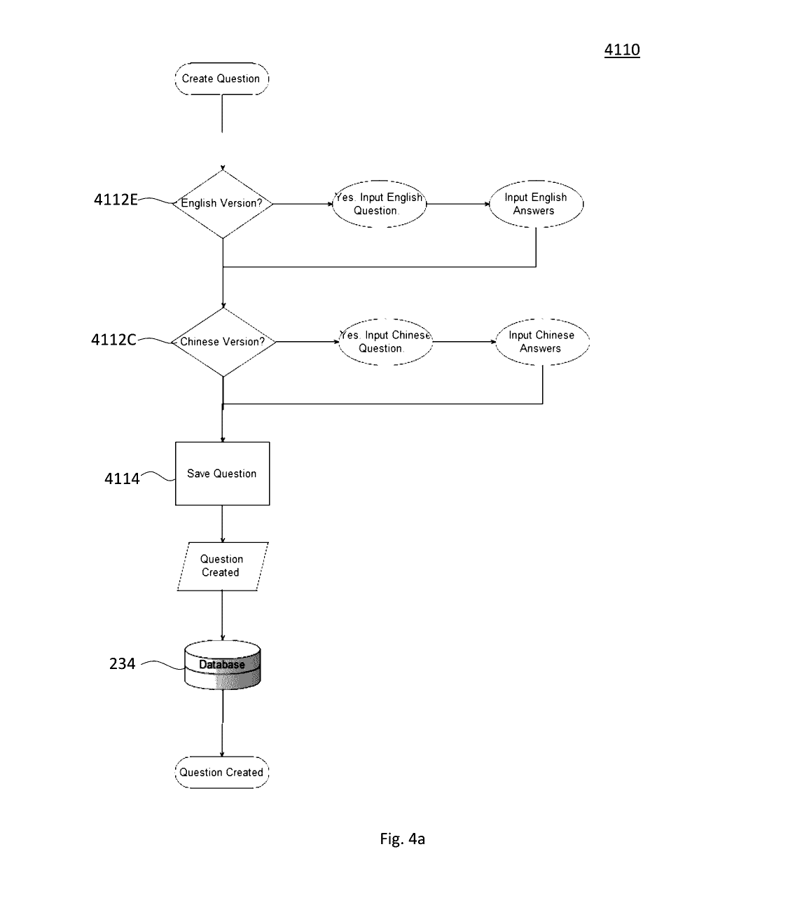

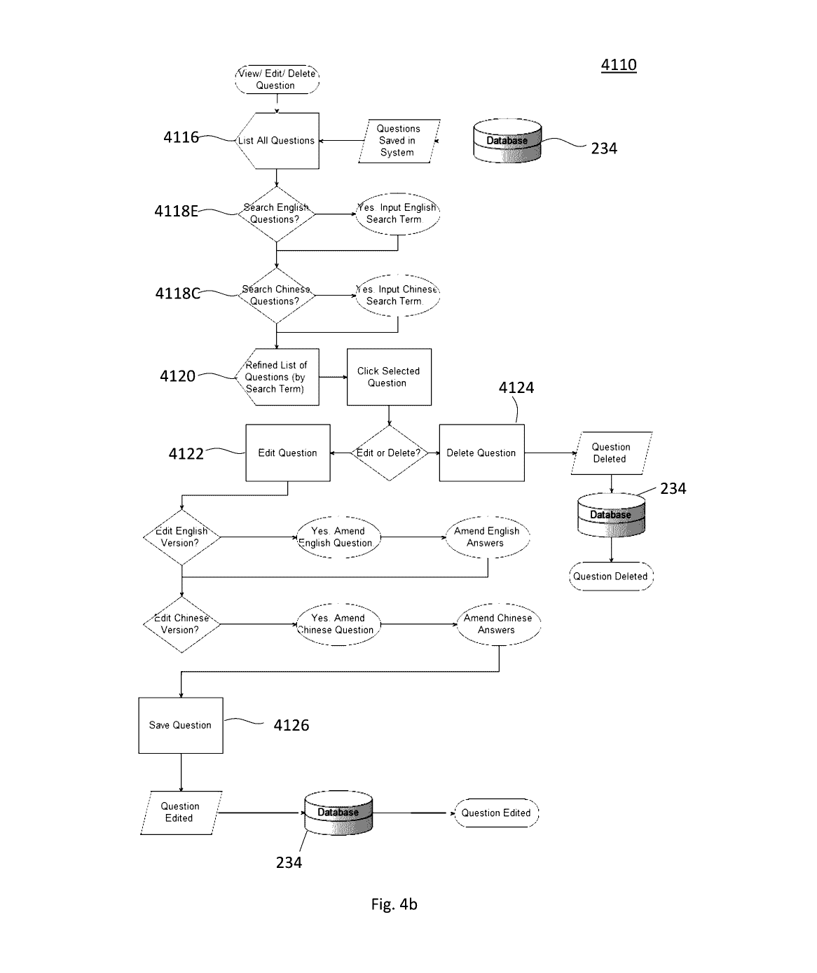

FIG. 4a shows an exemplary embodiment of a flow diagram 4110 of a process carried out by a question module 4100. Question module 4100 may be configured to manage questions. Recruiter may plan and develop a plurality of questions to be used to develop the reference form. Question module 4100 may be configured to create a question. Question module 4100 may be configured to create the question in more than one languages, e.g. English and/or Chinese in 4112. Upon creating the question, question module 4100 may be configured to allow the recruiter to save the question in 4114 in the question database 234.

FIG. 4b shows an exemplary flow diagram of additional steps of the process carried out by the question module 4100. Question module 4100 may be configured to delete or edit questions in the question database 234. Referring to FIG. 4b, the question module 4100 may be configured to retrieve a plurality of questions from the question database 234 in 4116. Recruiter may search the question database 234 in 4118. Search may be conducted in English in 4118E or Chinese in 4118C. Question module 4100 may be configured to allow the recruiter to refine the search in 4110. Upon retrieving the plurality of questions, the recruiter may choose to edit at least one question in 4122 or delete the question from the database 234 in 4124. Edited questions may be saved in the database 234. Upon saving the questions in the question database 234, the question database 234 may be configured to store a plurality of stock questions in 4126. Stock questions are questions that are available in the question database 234 for the recruiter to select from.

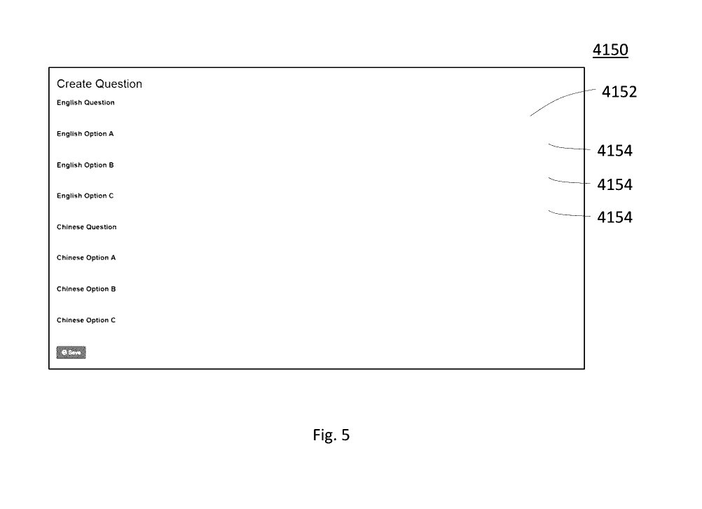

Question module 4100 may include a create-question user interface 4150 as shown in FIG. 5. Create-question user interface 4150 may be configured to allow the recruiter to create questions. Create-question user interface 4150 may be configured to allow the user to create multiple-choice questions. As shown in FIG. 5, the recruiter may create a question in question box 4152 and provide at least three options in option boxes 4154 for the reference provider to choose from. Question module 4100 may provide at least four options, five options, etc. Question module 4100 may be configured to allow the recruiter to create each question in at least two languages. When the recruiter creates a bilingual version of the question, the recruiter would be able to view the question in any one of the languages, e.g. English or Chinese, when he selects the language to display in the create-question user interface 4150. The bilingual option allows the recruiter to phrase the questions in exactly the way the recruiter wants, according to the nature of the language. This allows the recruiter to incorporate nuances in the questions, for the purpose of eliciting psychological responses from the references provider. When the question is created successfully, the recruiter has the option to review it. If the recruiter is satisfied, the recruiter can simply move on to other modules. The recruiter also has the option to edit or delete the question.

Plurality of questions may include at least one ipsative question. Ipsative question is a multiple-choice question where there is no obvious answer. Ipsative questions may have two or more answers which are being perceived as equally (or almost equally) “positive”. On the other hand, non-ipsative questions has only one “positive” answer, out of several “negative” answers. When reference providers respond to an ipsative question, the reference providers' responses, i.e. answers, to each question may be scattered. Thus, recruiter would be able to better identify the most suitable applicant (i.e. the applicant with the best suitability score) for the team. Plurality of questions may include at least one non-ipsative question.

Questions may include behavioural-focused questions. There are no right or wrong answers in behavioural-focused questions as the purpose of such questions is to find applicants with the closest behavioural characteristics to existing team members.

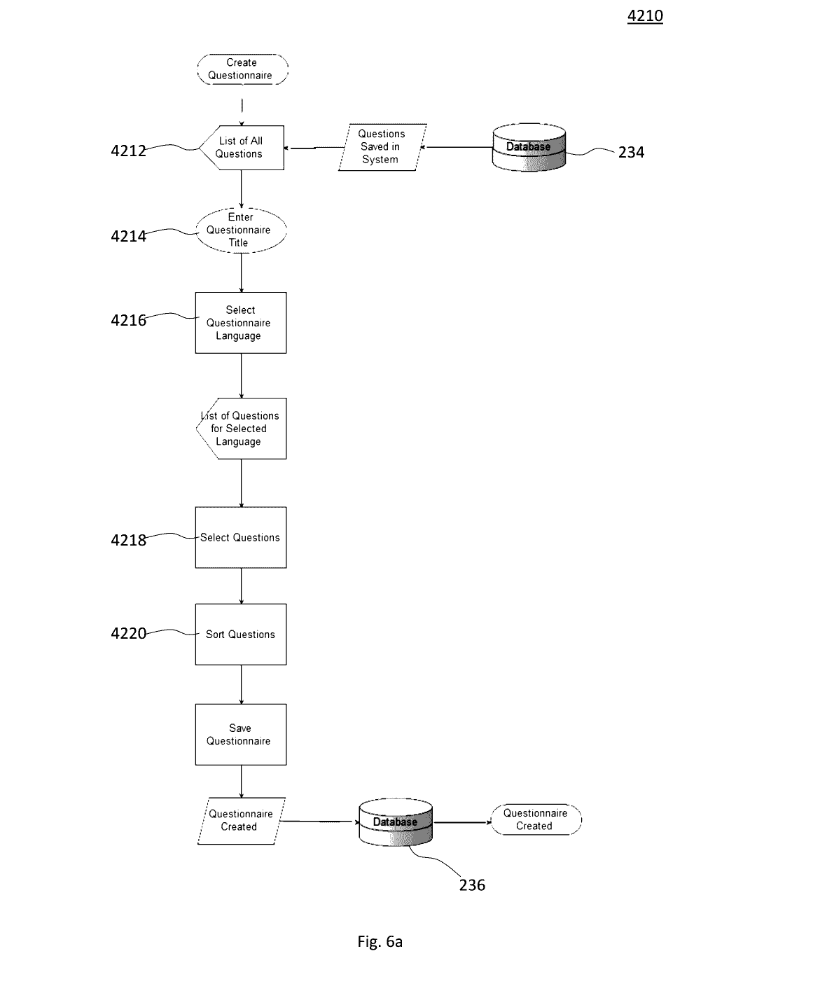

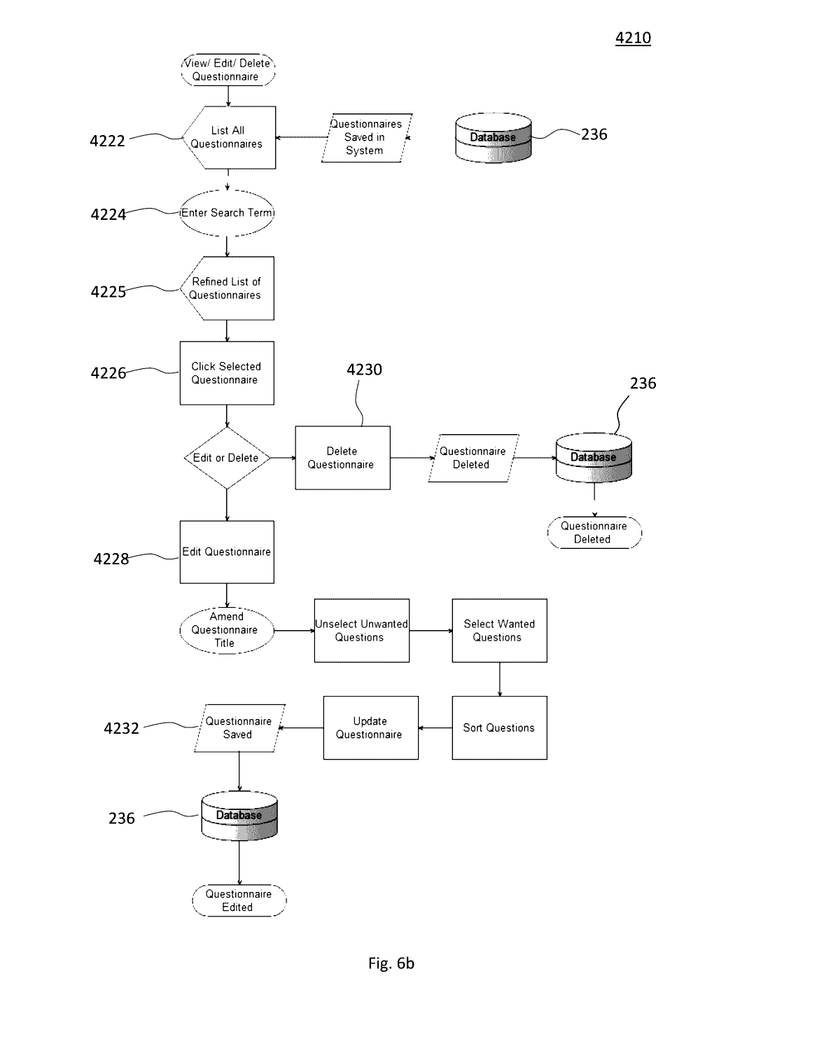

FIG. 6a shows an exemplary flow chart 4210 of a process carried out by the reference form module 4200. Reference form module 4200 is configured to manage the reference form. Referring to FIG. 6a, the recruiter may prepare the reference form using the reference form module 4200. Reference form module 4200 may be configured to create the reference form. Reference form may be a questionnaire. Reference form module 4200 may be configured to retrieve a plurality of questions from the question database 234 for the creation of the reference form in 4212. Reference form module 4200 may be configured to allow the recruiter to enter a reference form title in 4214. Reference form module 4200 may be configured to allow the recruiter to select the language for the reference form in 4216. Reference form module 4200 may be configured to allow the recruiter to select a plurality of questions from the stock questions in 4218. Reference form module 4200 may be configured to allow the recruiter to sort the plurality of selected questions in 4220. Recruiter may save the completed reference form in the reference form database 236. Plurality of questions may include selected questions relevant to the team. Plurality of questions may be selected based on the characteristic of the team. For example, marketing related questions may be relevant to a marketing team, medical related questions may be relevant to medical team.

FIG. 6b shows another flow diagram 4210 of additional steps of the process carried out by the reference form module 4200. Reference form module 4200 may be configured to add or delete at least one reference form to or from the reference form database 236. Reference form module 4200 may be configured to allow the recruiter to retrieve at least one reference form from the reference form database 236. Reference form module 4200 may be configured to allow the recruiter to search for at least one reference form from the plurality of reference forms in the reference form database 236 in 4222. From the search, the recruiter may receive a refined list of reference forms in 4225. Reference form module 4200 may be configured to allow the recruiter to select at least one reference form in 4226.

Reference form module 4200 may be configured to edit or delete at least one of the plurality of reference forms in 4228 and 4230 respectively. For editing of a reference form, the reference form module 4200 may be configured to unselect unwanted questions, select wanted questions, or sort the plurality of questions in the reference form. Upon completion of the editing of the reference form, the edited reference form may be saved in the reference form database 236 in 4232.

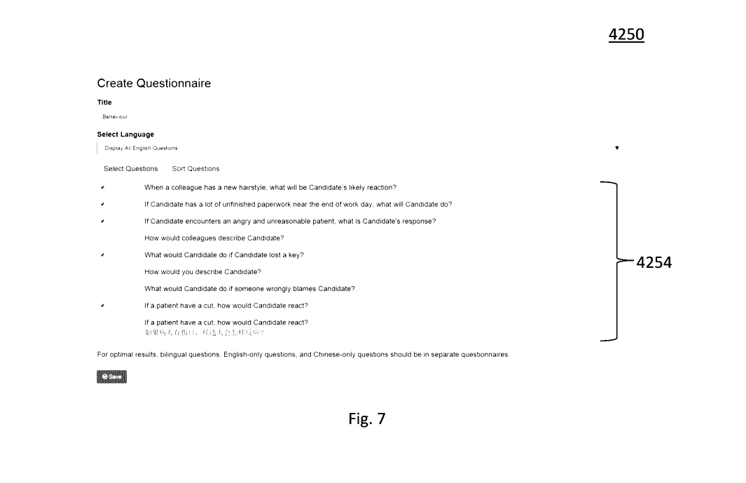

FIG. 7 shows an exemplary embodiment of a create-reference-form user interface 4250. Reference form module 4200 may include a create-reference-form user interface 4250 configured to display questions and receive input, e.g. instructions, choices, from the recruiter. FIG. 7 shows an embodiment of the create-reference-form user interface 4250. Recruiter may view the plurality of stock questions 4254 in the question database 234 and select a plurality of selected questions for a reference form. Create-reference-form user interface 4250 may display the plurality of questions for the recruiter to view. Recruiter may search from the plurality of stock questions to select the plurality of questions for the reference form. At the create-reference-form user interface 4250, the recruiter may click and drag the questions to the desired sequence or location.

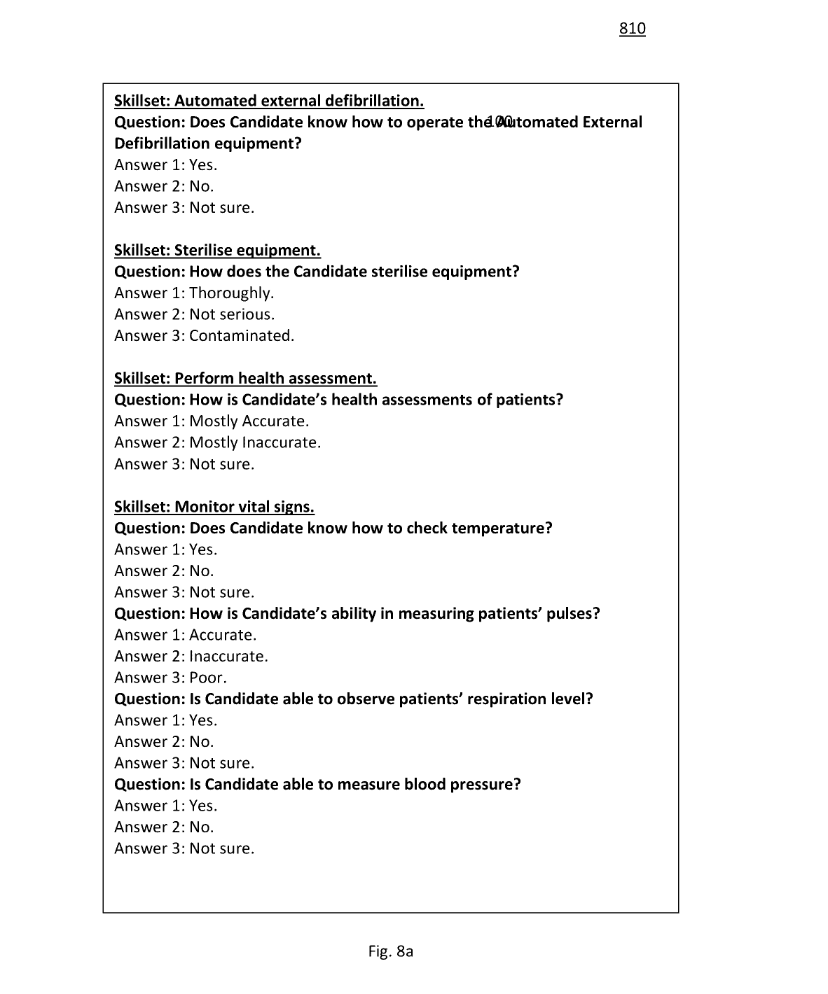

FIGS. 8a and 8b show an example of the reference form 810 having a plurality of questions. Plurality of questions may include at least one of an ipsative question, a non-ipsative question, or an open-ended question, etc. Plurality of questions may include at least one of multiple choice question, or numerical-based question, e.g. Likert Scale. It is recommended to provide multiple choice question than numerical-based question so that the reference provider will be allowed to select only one of the answers to a multiple choice question to allow for more effective comparison of the applicant reference data and the team reference data. Multiple-choice question may be used to force the reference provider to provide decisive answers. Numerical-based question can be subjected to the relative strictness (leniency) at which reference provider respond to the reference form.

Reference form module 4200 may include a reference form user interface. Recruiter may be able to enter a search term into the reference form user interface to search for at least one reference form. Reference form module 4200 may retrieve at least one reference form which is relevant to the search term. Reference form module 4200 may display the at least one reference form in the reference form user interface. Recruiter may review the plurality of questions in each of the at least one reference form. Reference form module 4200 may be configured to allow the recruiter to sort the plurality of questions in each reference form according to the preference of the recruiter. At the reference form user interface 4250, the recruiter may click and drag the questions to the desired sequence or location.

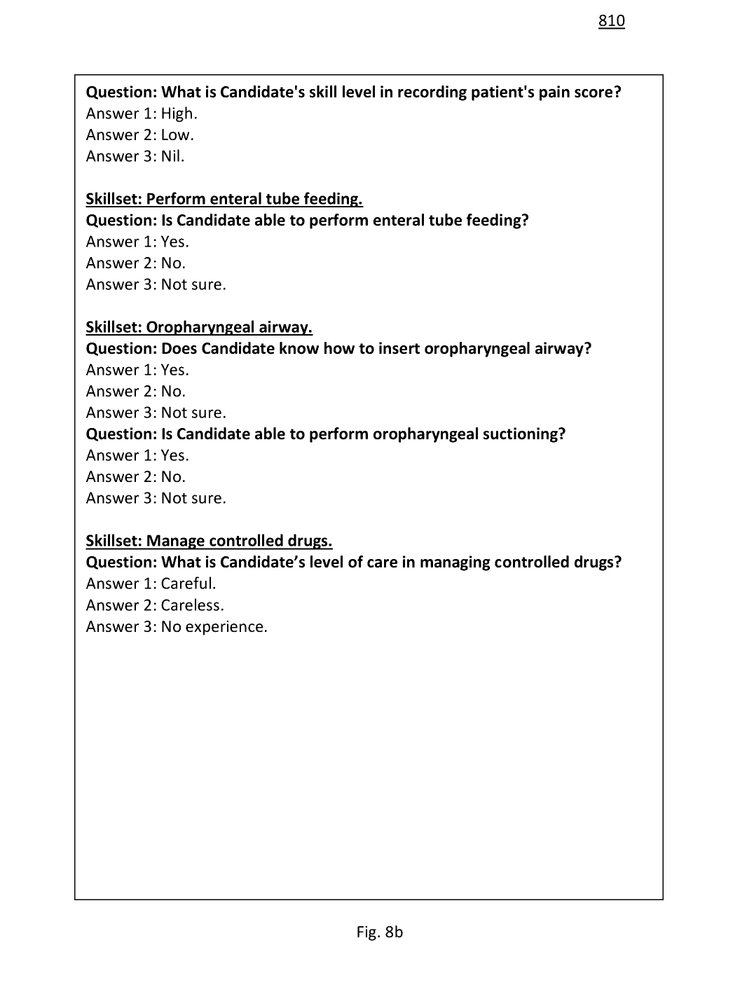

Server 210 may include a recruiter module. Recruiter module may be configured to manage information of the recruiter, e.g. recruiter profile like username, email, gender, identification number, company, mobile phone number, job title, full name, address, nationality, etc. FIG. 9 shows a recruiter user interface 4950. Recruiter module may include the recruiter user interface 4950 configured to display and receive information of the recruiter. Recruiter module may be configured to receive and/or allow the recruiter to edit the information of the recruiter in the recruiter user interface 4950. Recruiter module may include a password module configured to receive a first time password from the recruiter. Password module may be configured to receive a log in password from the recruiter and verify the log in password against the first time password. Upon positive verification, the recruiter would then be allowed into the other modules.

Recruiter may be people who scout for and/or recruit employees. Recruiters may include recruitment agents, employment agents, human resource managers, line managers, head of departments, general managers, chief executive officers, managing directors. Recruiter module may be configured to store personal or company information of the recruiter.

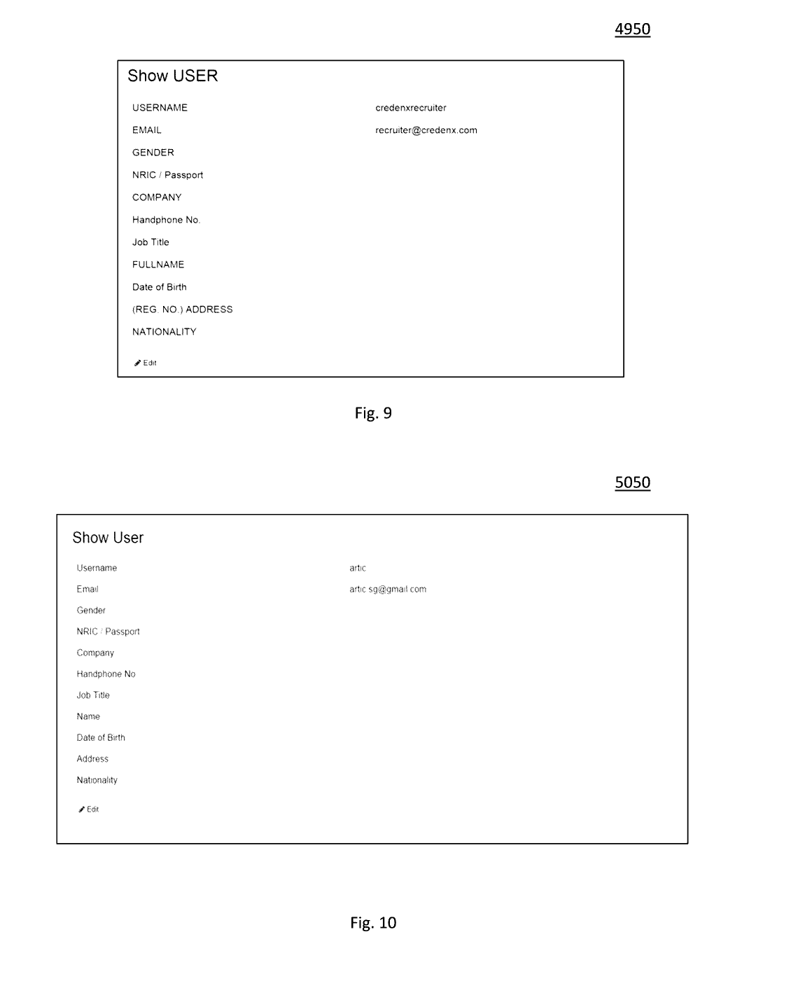

FIG. 10 shows an example of an applicant user interface 5050. Server 210 may include an applicant user interface 5050 may be configured to manage information of the applicant like username, email, gender, identification number, company, mobile phone number, job title, full name, address, nationality, etc. Applicant user interface 5050 may be configured to receive and/or allow the applicant to edit the information of the applicant.

Team module 4300 may be configured to manage data of the team. Team module 4300 may be configured to create, delete or edit teams. Team module 4300 may be configured to add or remove a team member or an applicant to or from the team.

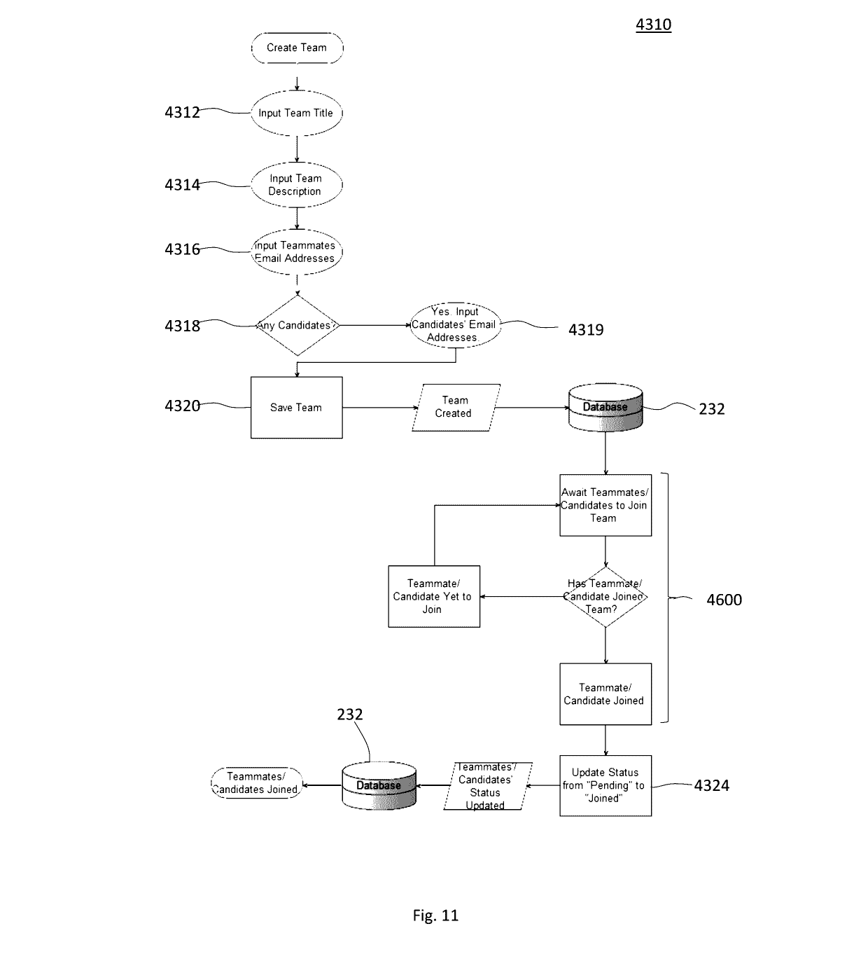

FIG. 11 shows an exemplary embodiment of a flow diagram 4310 of a process carried out by the team module 4300. Team module 4300 may be configured to create teams. Team module 4300 may be configured to receive a team title and/or team description for the team in 4312 and 4314 respectively. Team module 4300 may be configured to receive email addresses of the team members. Team member email address may be provided by the recruiter. Team module 4300 may be configured to seek the recruiter's input whether an applicant is to be included in the team in 4318. If so, the team module 4300 may be configured to receive email address of the applicant in 4319. Applicant email address may be provided by the recruiter. Team module 4300 may be configured to allow the recruiter to save the team details in the team database 232 in 4320. Team database 232 may be configured to store the team data of at least one team in 4320. Team data may include a team ID, team title, team description, number of team members, etc. Team module 4300 may include a join module 4600 which will be explained in detail later.

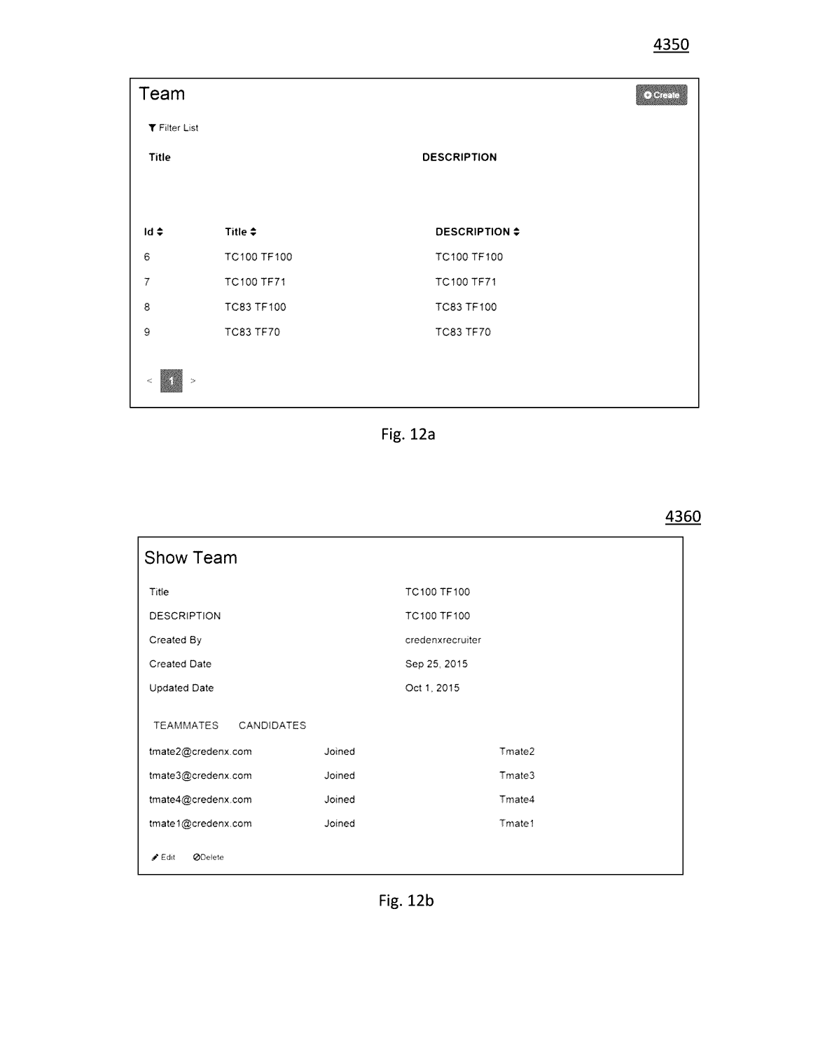

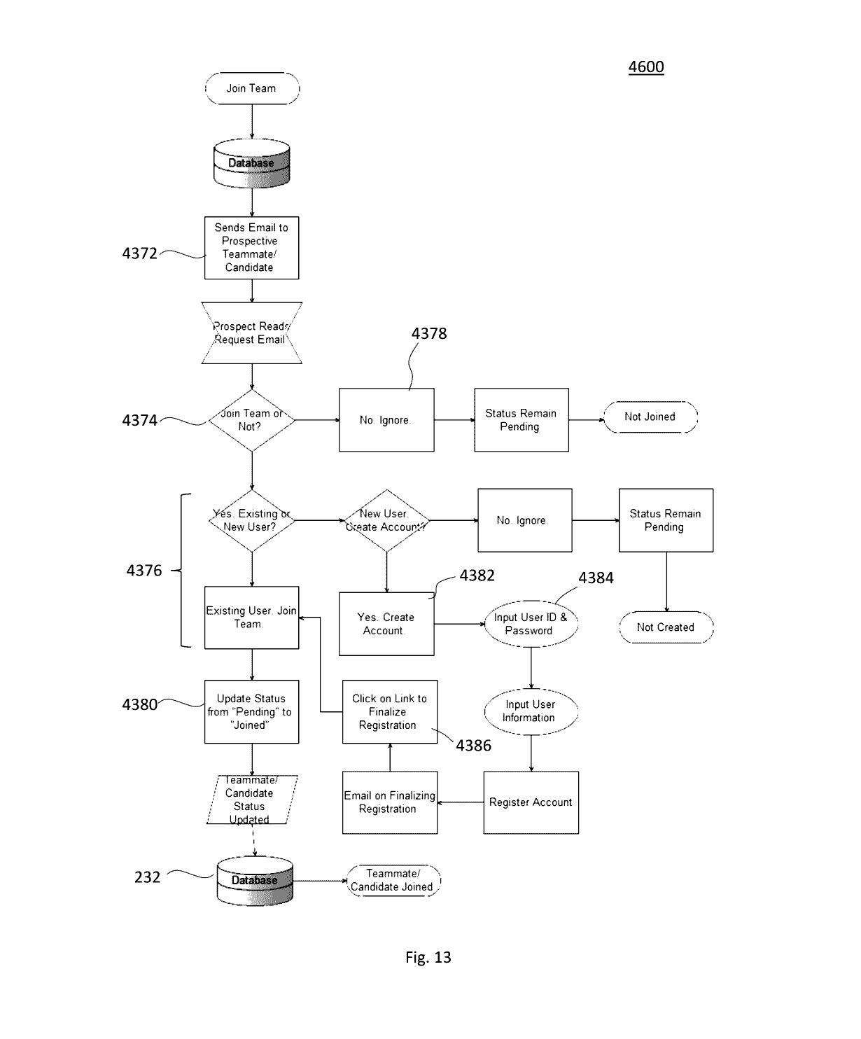

Team module 4300 may include a team display interface 4350 as shown in FIG. 12a. Team display interface 4350 may be configured to display the teams. Team module 4300 may be configured to allow the recruiter to search for a team by receiving a team search query. Team module 4300 may be configured to display a list of teams for the recruiter to select.

Team module 4300 may be configured to add or remove an applicant to the team. Recruiter may add or remove the applicant from the team using the team module 4300. Team module 4300 may include a join module 4600 configured to manage the joining of the applicant to the team (shown in FIG. 11). To include the applicant in the team, a notification may first be sent to the applicant for the applicant to confirm joining of the team for the evaluation. A detailed description of getting the applicant to join the team may be elaborated later. As shown in FIG. 11, the team module 4300 may be configured to accept the confirmation from the applicant in 4600. Upon receiving the confirmation, the team module 4300 may be configured to update the status of the applicant from ‘Pending’ to ‘Joined’ in 4324 and save the status in the team database 232.

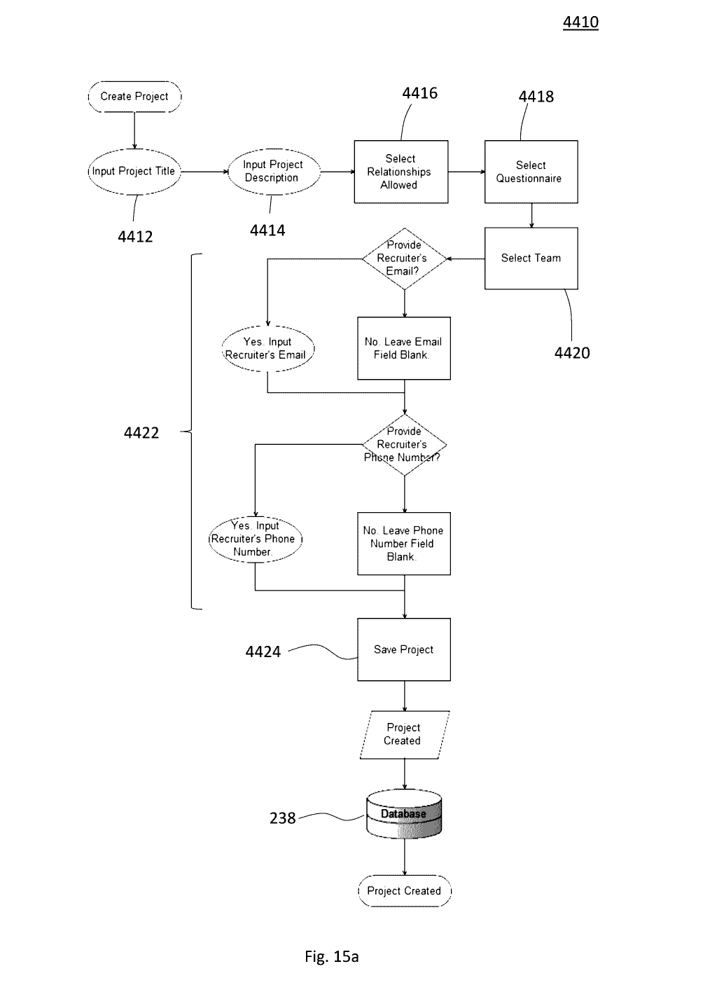

FIG. 12b shows an embodiment of a team user interface 4360. As shown in FIG. 12b, the recruiter may be able to see the applicants, e.g. candidates and/or team member, and the team members in each team. Team user interface 4360 may be configured to display the status of each team member, e.g. joined. Team members may be identified by a unique identifier, e.g. name, identification number, email address. Recruiter may add or remove an applicant to or from the team. Recruiter may edit information of the team. Team user interface 4360 may be configured to allow the recruiter to send a notification, e.g. join notification (see FIG. 14), to the applicant's email address in the team user interface 4360.

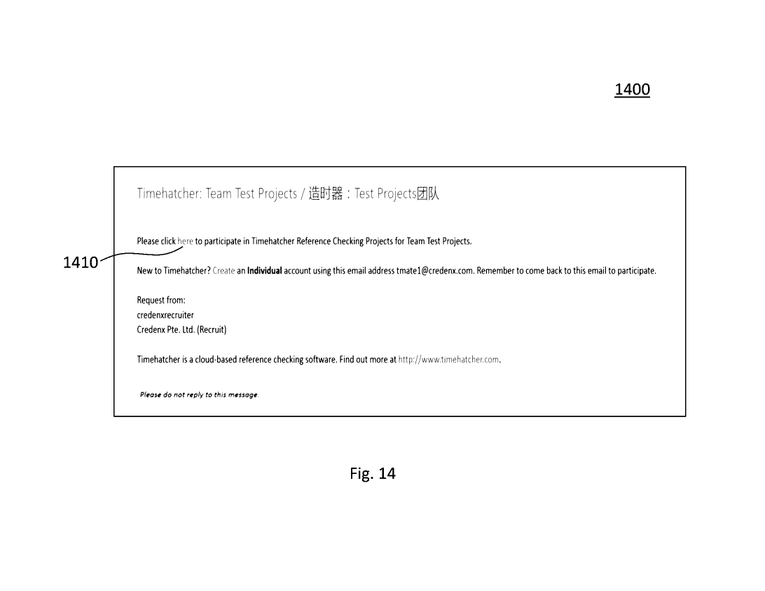

FIG. 13 shows an exemplary embodiment of a flow diagram of a process carried out by the join module 4600. When the recruiter wishes to evaluate an applicant, the join module 4600 may be configured to send a join notification 1400, e.g. an email, to the applicant, e.g. to the email addresses of the applicant in 4372. FIG. 14 shows an example of the join notification 1400. Join notification 1400 may include an acknowledgement module 1410, e.g. an acknowledgement link, configured to allow the applicant to make an input, e.g. click on the link, to join the team so as to participate in the evaluation. As shown in FIG. 13, the applicant may decide whether to join the team to be evaluated or not in 4374. Join module 4600 may be configured to allow the applicant to join the team. Applicant has to make the input in the acknowledgement module 1410 to join the recruiter's team in 4376. If a notification 1400 has been sent and the applicant did not acknowledge the notification 1400 in 4378, the status of the applicant in the team would be “Pending”. When the applicant makes an input in the acknowledgement module 1410, the status of the applicant in the Team would be updated to “Joined” in 4380 in the team database 232. Upon receipt of the acknowledge input from the applicant, the server 210 may toggle the “Pending” status of the applicant in the join module 4600 to “Joined”.

Applicant may be required to have an existing account registered with the recruiter in order to be able to join recruiter's team. If an applicant is new to system, the applicant may create an account in 4382. Applicant may input a user ID and password in 4384 and return to the notification 1400 to click on the acknowledgement module 1410 to finalise the registration in 4386 to join recruiter's team for the suitability evaluation. It is important to note at this point that the joining of the applicant to the team does not mean that the applicant has joined the physical team. Rather, the applicant has to join the team in the system, e.g. a virtual team, to be evaluated against the team for the suitability of the applicant to the team.

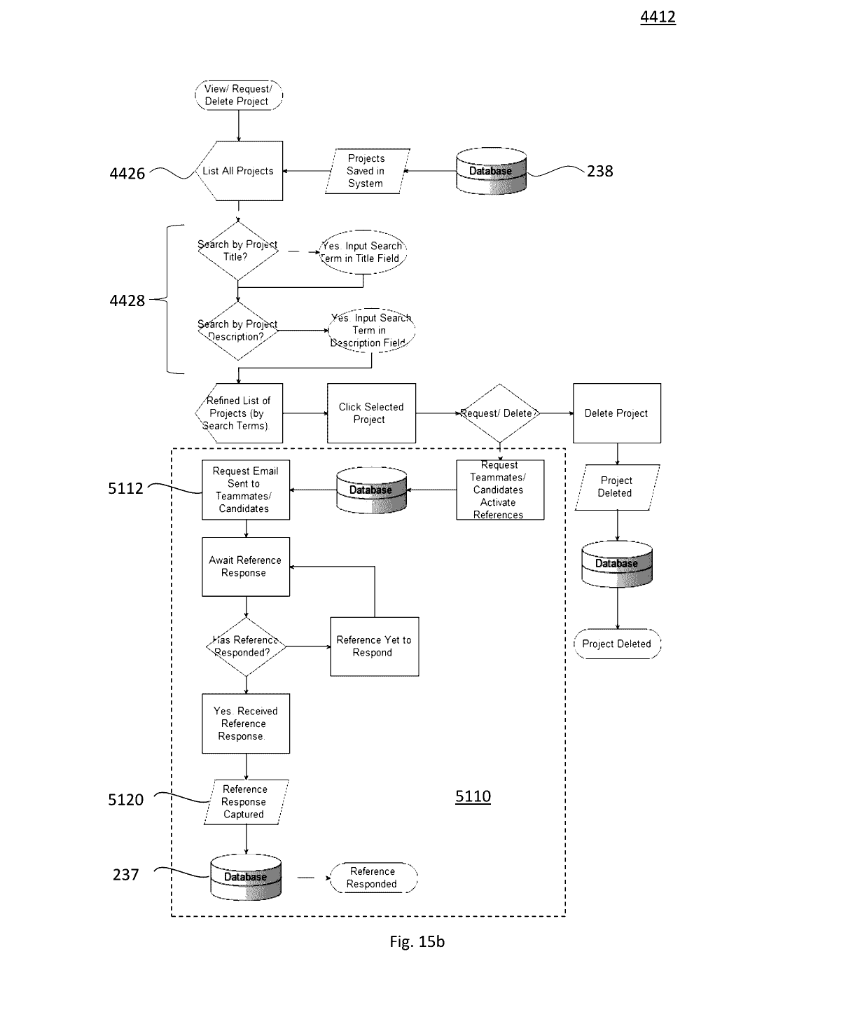

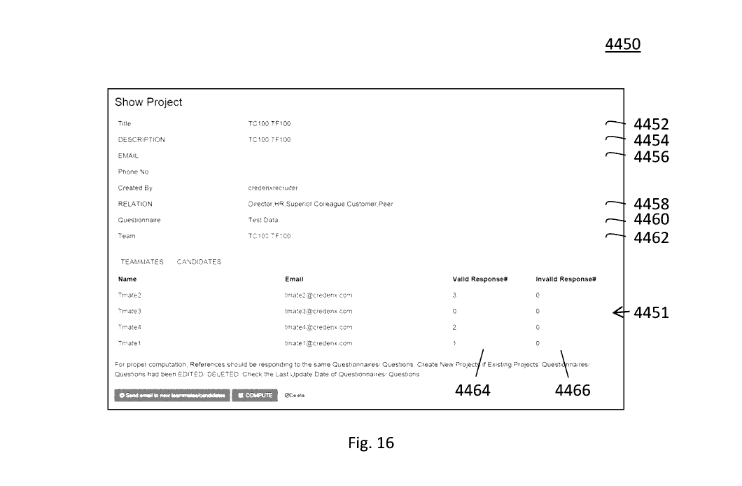

Server 210 may include the project module 4400 configured to manage a project for evaluating the suitability of the applicant for the team. FIG. 15a shows an exemplary embodiment of a flow diagram 4410 of a process carried out by the project module 4400. Project module 4400 may be configured to receive a project title and/or description from the recruiter in 4412 and 4414 respectively. Project module 4400 may be configured to allow the recruiter to select the relationship category between the applicant and the reference provider that is allowed for the project, e.g. director, peer, in 4416. Project module 4400 may be configured to allow the recruiter to select the reference form from the reference form database 236 for the project in 4418. Project module 4400 may be configured to allow the recruiter to select the team for the project in 4420. Project module 4400 may be configured to receive the recruiter's details, e.g. email, phone number, in 4422. Project module 4400 may be configured to save the project in the project database 238 in 4424.

Referring to FIG. 15b shows an exemplary embodiment of a flow diagram 4412 of additional steps of the process carried out by the project module 4400. Project module 4400 may be configured to display the project details on a device, e.g. the recruiter's device 240. Project module 4400 may be configured to display a list of projects on the device in 4426. Project module 4400 may be configured to search the list of projects in the project database 238 in 4428. Recruiter may be able to search for a project by the title or the description. Project module 4400 may be configured to delete a project from the project database 238. Project module 4400 may be incorporated with the reference module 5100 configured to manage the receipt of reference response from the reference provider. Flow diagram 4412 may incorporate a flow diagram 5110 of the reference module 5100.

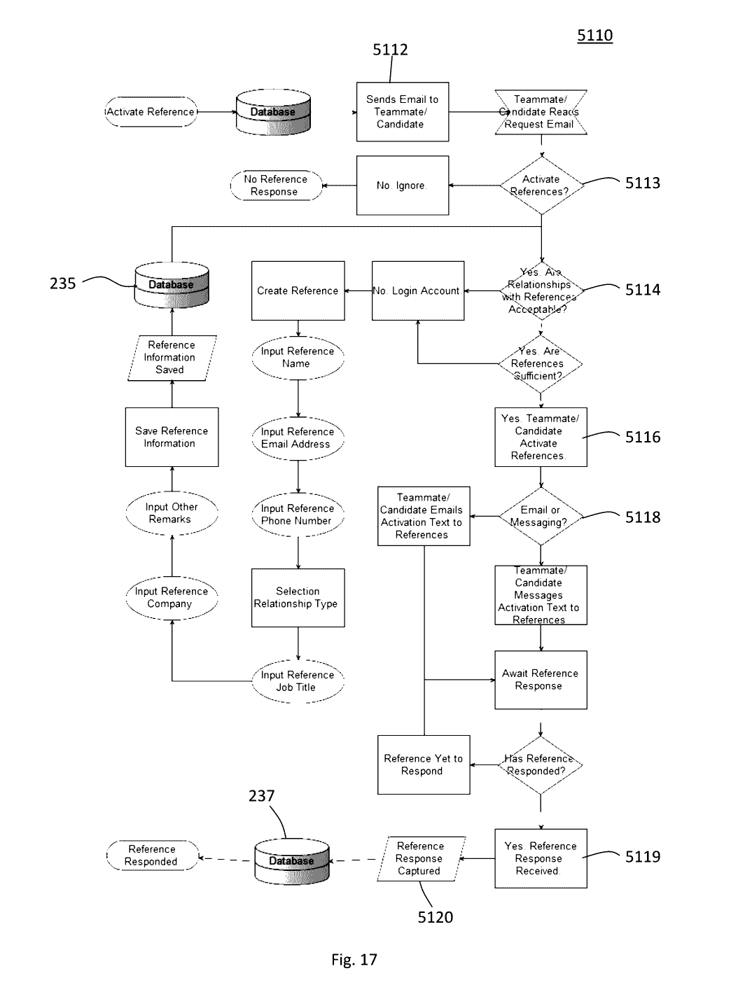

FIG. 16 shows an example of a project user interface 4450. Project user interface 4450 may be configured to display information of the team members in a selected team in 4451. As shown in FIG. 16, the project user interface 4450 may include information like the team member's name, e.g. real name, username, and email address. Other information like title, age may also be included. Project user interface 4450 may display information like project title 4452, description 4454, contact details 4456, relationship category requirement 4458, reference form used 4460, team 4462, etc.

Project user interface 4450 may include a valid response field 4464 (third column) which is the number of valid reference response received for each team member. A valid reference response refers to a reference response that has satisfied the requirements in the reference response. Team member user interface may include an invalid response field 4466 (fourth column) which is the number of invalid reference response received for each team member.

A validity requirement may be the requirement of a qualified reference provider who has responded to the reference form for the team member. A qualified reference provider may be a reference provider that has the allowed relationship category between the reference provider and the team member. For example, the server 210 would verify that the relationship category of the reference provider for a team member in the reference response has to be a “Superior” if the project requires that the reference provider of the team member to be a superior of the team member. If the relationship category of the reference provider satisfies the requirement, the reference response would be a valid reference response. Project user interface 4450 may include an invalid response field received for each member. If the relationship category of the reference provider does not satisfy the requirement above, the reference response would be an invalid reference response.

Another validity requirement may be the accuracy of the details of the reference provider. Details of the reference provider in the reference response may be matched against the details of the reference provider as provided by the team member. A valid reference response may be one which has the correct details of the reference provider provided by the team member.

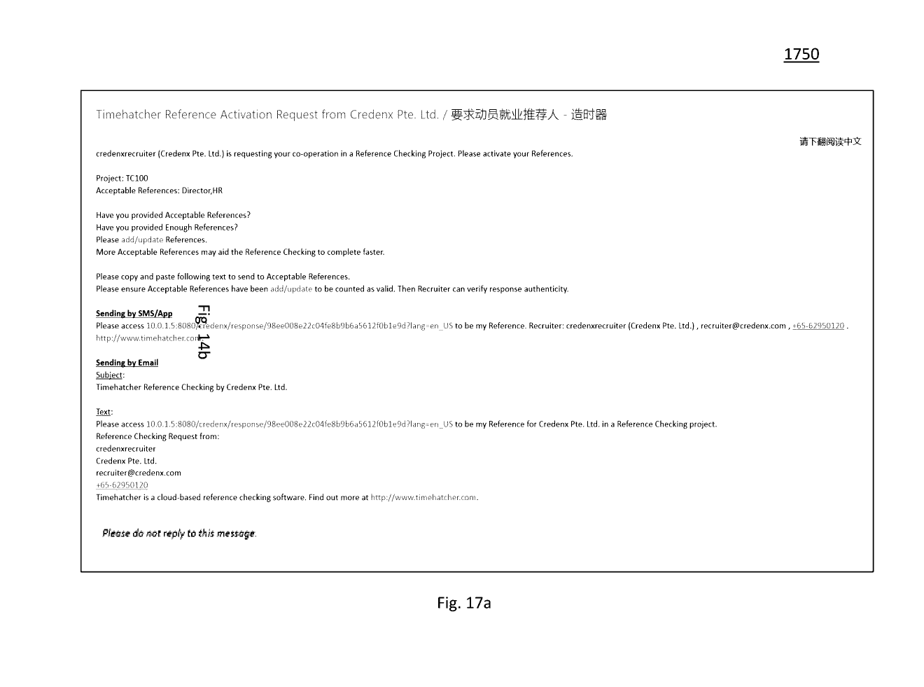

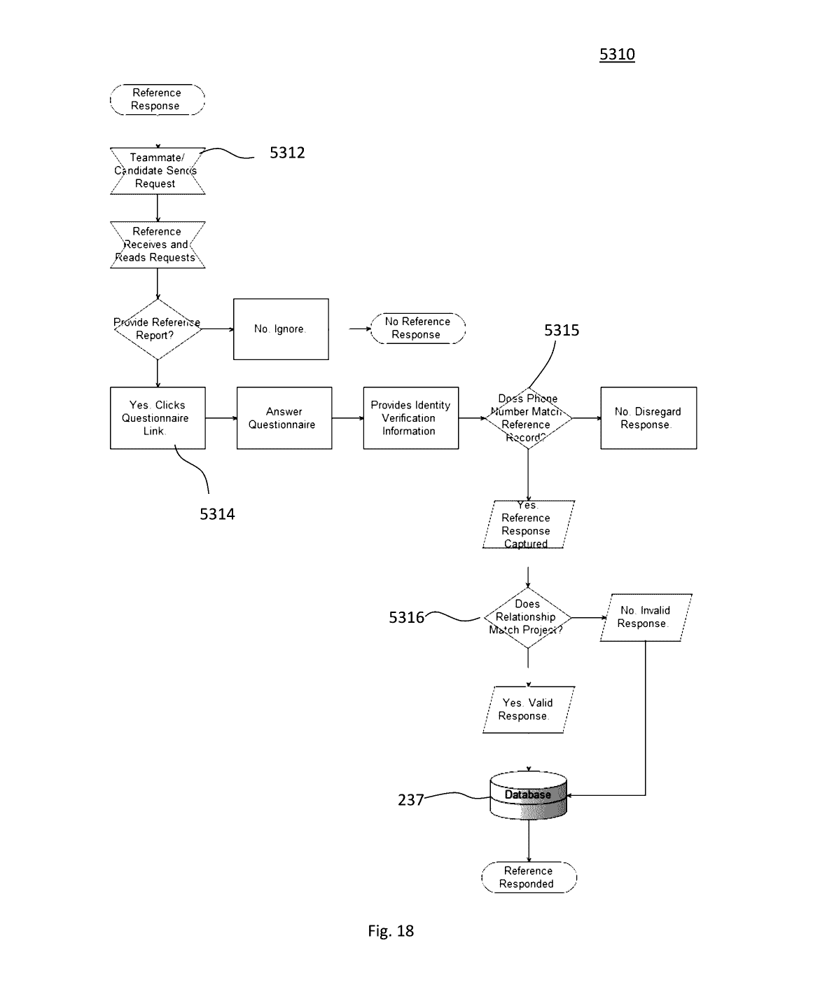

Project module 4400 may include a reference module 5100 (refer to FIG. 15b) configured to manage the reference response from the reference provider. Upon commencement of the project, the recruiter may request for the activation of a reference provider. Reference module 5100 may be configured to transmit an activation notification 1750 (see FIG. 17) to the applicant to request for a response from the reference provider in 5112. Upon receipt of the response from the reference provider, the response may be saved in a reference response database 237 in 5120.

Server 210 may include the reference module 5100 configured to manage the reference response from the reference provider. FIG. 17 shows an exemplary flow diagram 5110 of a process carried out by the reference module 5100. FIG. 17a shows an exemplary embodiment of an activation notification 1750. Reference module 5100 may be configured to transmit the activation notification 1750 to the applicant in 5112. Applicant may decide if he or she wishes to activate the reference provider in 5113. Applicant may transmit the activation notification 1750 to the reference provider if the applicant wishes to activate the reference provider. Applicant may copy the content in the activation notification 1750 and paste it into an email or a short message to be forwarded to the reference provider. By transmitting the notification 1750, the applicant “activates” the reference provider. When the recruiter creates a project, the reference module 5100 may be activated by the project module 4400 to transmit the notification 1750 to the applicant. Activating a reference provider includes allowing the reference provider to participate as a reference provider. Reference module 5100 may be configured to monitor the acknowledgement from the reference provider. Reference module 5100 may be configured to activate the reference provider of the applicant by transmitting the activation notification 1750 directly to the reference provider. Reference module 5100 may include identifying and/or authenticating the reference provider of the reference response. Reference provider may have to be activated before the reference response of the reference provider can be accepted and saved into the reference response database 237. Reference module 5100 may be configured to identify if a reference provider is in the reference provider database 235. If the reference provider is not in the reference provider database 235, the reference module 5100 may be configured to receive and store details of the reference provider. Reference provider details may include name, email address, mobile number, relationship with applicant, job title, company name, etc. Details of the reference provider may be linked or tagged to the record of the applicant in the applicant database 239. Details of the reference provider may be stored in the applicant database 239.

Applicant may verify if the relationship of the reference provider and him or herself meets the relationship category required by the recruiter. Reference module 5100 may be configured to verify the relationship category of the reference provider to the applicant in 5114. Recruiter may configure the reference module 5100 to accept the reference response from reference providers from a certain reference category, e.g. superior. Recruiter may configure the reference module 5100 to accept more than one relationship category. Upon affirming that the relationship category requirement of the reference response is met, the applicant may activate the reference provider by forwarding the activation notification 1750 to the reference provider in 5116. Applicant may forward the activation notification 1750 via, e.g. an email, message, to the reference provider for the reference provider to acknowledge and provide consent to the activation of the reference provider in 5118. Applicant may copy the content in the activation notification 1750 and paste it into an email or a short message to be forwarded to the reference provider. Reference module 5100 may be configured to activate the reference provider when the reference provider meets the relationship category required by the recruiter. Reference module 5100 may be configured to forward the activation notification, e.g. via email, message, to the reference provider for the reference provider to acknowledge and provide consent to the activation of the reference provider. Reference module 5100 may be configured to receive a response from the reference provider in 5119. Reference module 5100 may be configured to store the reference provider response in the reference provider database 235 in 5120.

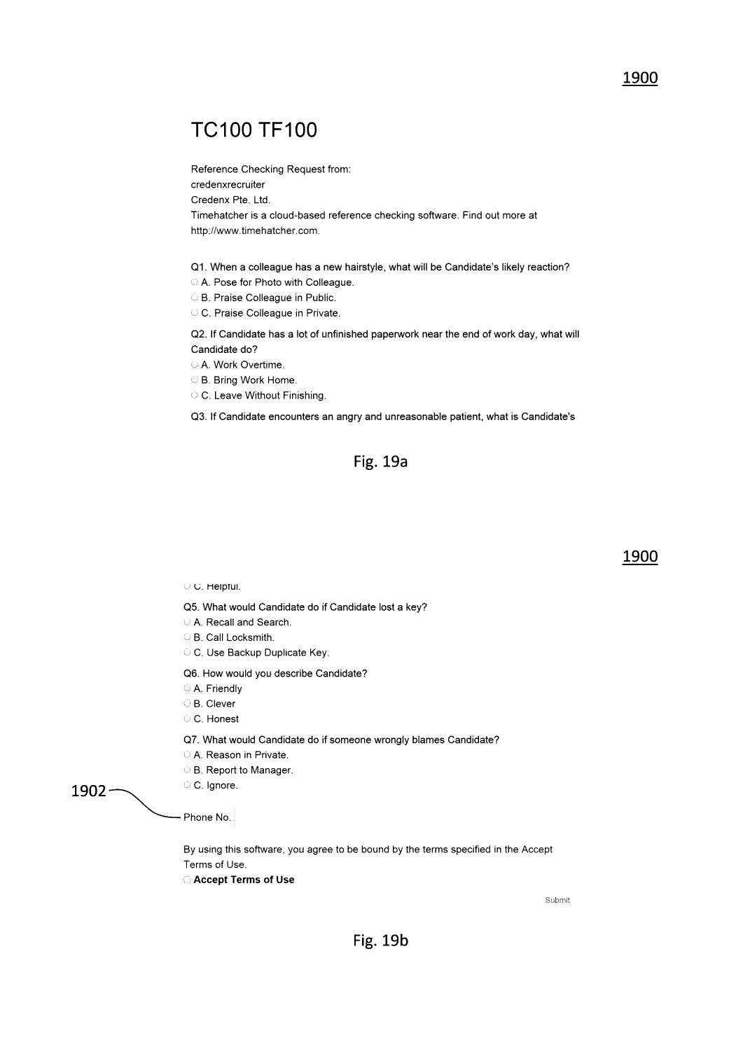

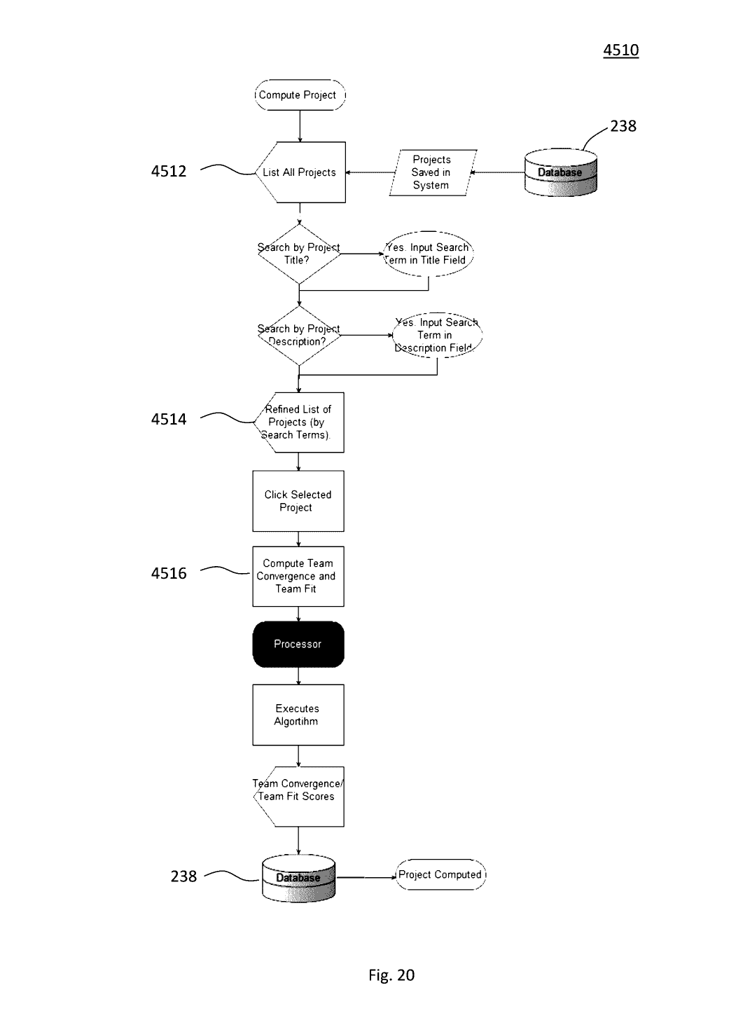

FIG. 18 shows an exemplary flow diagram 5310 of a process carried out by a reference response module 5300 configured to manage the reference response. Reference response module 5300 may be configured to transmit the reference form to the applicant in 5312. Applicant may forward the reference form to the reference provider. Reference response module 5300 may be configured to forward a link, i.e. URL link, of the reference form to the applicant. Applicant may forward the link of the reference form to the reference provider. Each link forwarded to the applicant/reference provider may be a unique link. Server 210 may generate a link that is unique to the applicant for the project. Server 210 may generate the unique link for each project-applicant combination. Unique link may be linked to the reference form meant for a distinct applicant in a distinct project. The unique link enables the server 210 to tag the reference response to the correct applicant for the correct project. Another applicant for the same project may have another unique link. The same applicant for another project may have another unique link. Applicant may forward the reference form to the reference provider via email or mobile messaging services. Reference provider, when receiving the reference form, may respond to the plurality of the questions in the reference form. Reference provider may receive the link from the applicant. FIGS. 19a and 19b show an example of an online reference form 1900. Reference provider may access the online reference form 1900 by clicking on the link in 5314 and the online reference form 1900 would be displayed on the reference provider device 260 (not shown in FIG. 18). When responding to the reference form, the reference provider would have to provide an authentication data, e.g. mobile number, email address, in an authentication field (see FIG. 19b). Server 210 may authenticate the authentication data against the details of the reference provider provided by the applicant to verify the identity of the reference provider in 5315. Reference response may be ignored if the authentication fails. Upon authentication, the applicant may wish to ensure that the reference provider that the applicant is sending the reference form to meets the relationship category requirement set by the recruiter in 5316. If the relationship between the reference provider and the applicant matches relationship category provided by the applicant, the reference response may be considered as a valid reference response. Otherwise, the response would be considered as an invalid reference response. It may be possible that the server 210 authenticates the reference response without matching the relationship category and vice versa. As shown in FIG. 19b, the reference provider may input his or her details, e.g. mobile number, email address in an authentication field 1902 in the reference form as the authentication data. The details may be used by the authentication module to authenticate the reference form in 5315. Particularly, to authenticate the identity of the reference provider to ensure that the reference provider responding to the reference form is the same reference provider that was provided by the applicant. In addition, it is possible to track whether the reference provider has responded to the reference form. Reference response may be captured and stored in the reference response database 237.

Reference response may include an authentication data. Authentication data may be a detail of the reference provider, e.g. mobile number, email address, address. Server 210 may include an authenticating module configured to authenticate the reference response. Authenticating module may use details of reference provider provided by the applicant to authenticate the reference response, e.g. by verifying the detail of the reference provider with the authentication data in the reference response. If the details of the reference provider matches the details of the reference response provided by the applicant, a reference response may be a valid reference response. Otherwise, the reference response may be an invalid response.

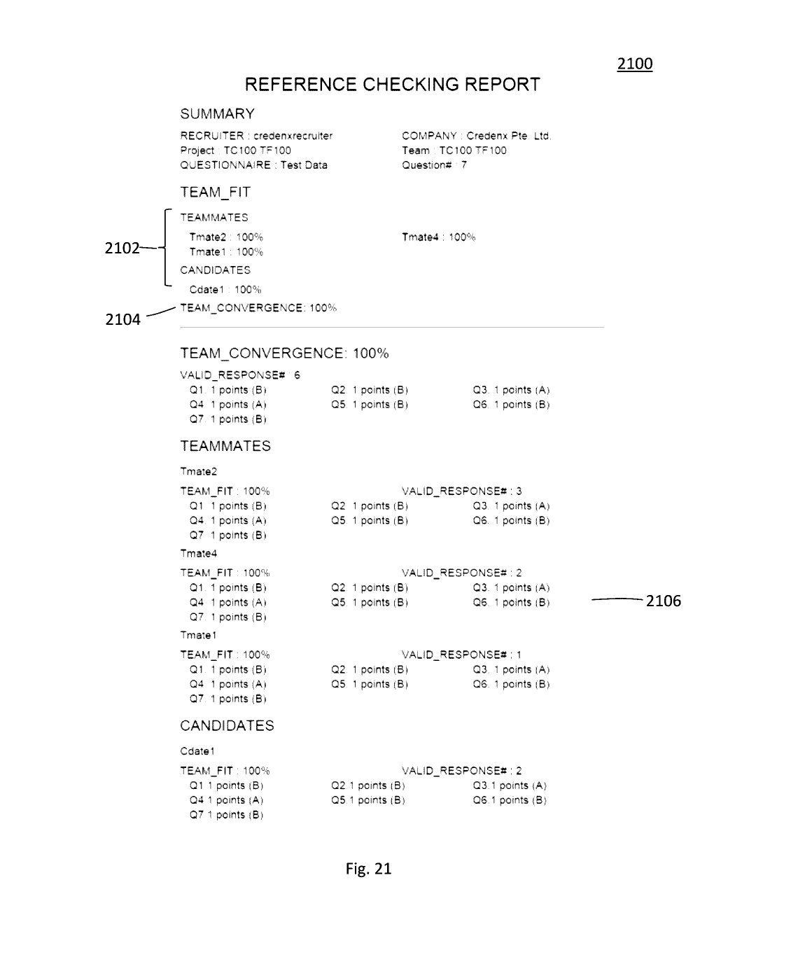

Server 210 may include a compute module 4500 configured to compute the suitability score. FIG. 20 shows an exemplary flow diagram 4510 of a process carried out by the computer module 4500. Compute module 4500 may be configured to display a list of projects in 4512 retrieved from the project database 238. Compute module 4500 may be configured to search a project in the project database 238. Recruiter may search for a project at least by the project title or project description. From the search, the compute module 4500 may be configured to display a refined list of projects on the device, e.g. recruiter′ device 240, in 4514. Compute module 4500 may be configured to compute a team convergence score based on the team reference data in 4516. Compute module 4500 may be configured to compute the suitability score based on the applicant reference data and the team reference data in 4516. Compute module 4500 may be configured to compute and obtain the team convergence score and suitability score. Compute module 4500 may be configured to store the team convergence score and the suitability score into the project database 238.

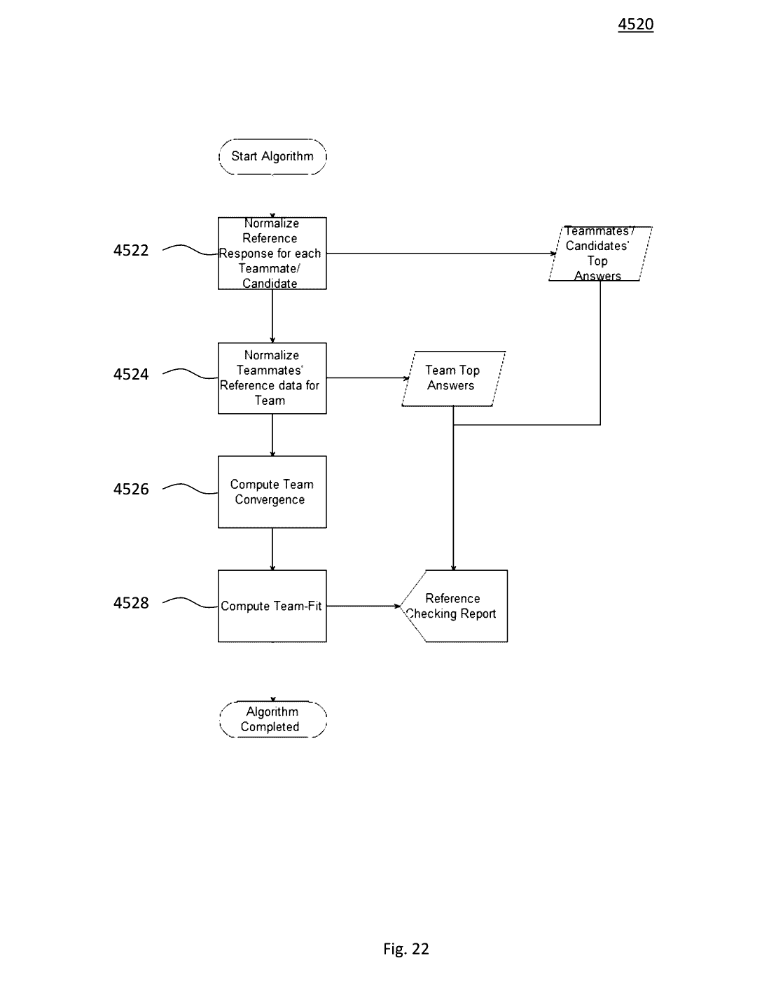

Server 210 may be configured to display the computed results, i.e. the suitability score. Suitability score is based on the applicant reference data with respect to the team reference data. FIG. 21 shows a suitability score report 2100. As shown in FIG. 21, the suitability report may include at least the suitability score 2102 of the team member/applicant, the team convergence score 2104. Suitability score report 2100 may include a score for each of the answers for each of the plurality of questions in 2106.

Team module 4300 may be configured to compute or calculate a team convergence score based on the team reference data. Team module 4300 may include a computing module configured to compute a team convergence score based on the team reference data. Team convergence score indicates a similarity level between team members in the team. Recruiters are able to calculate the team convergence score for each team. Based on the team reference data, the compute module 4500 may be configured to obtain a team convergence score which measures the frequency of each response obtained for each of the plurality of questions in each reference form from the plurality of reference forms of the team members. Team convergence score can be used to epitomize the “team spirit”. It represents how close the team members are in terms of behavioural traits. Team convergence score is based on various behavioural attributes set by the recruiter. Method 100 may be configured to use of the team convergence score to find the suitable applicant for each prospective team member. Server 210 may be configured to ensure that the reference provider answers all the questions in the reference form. Server 210 may be configured to prompt the reference provider to respond to any omitted questions. Server 210 may be configured to allow the reference provider to submit the reference response of the reference form only when all the questions have been answered. For a reference form with multiple choice questions, each question of the reference form for the applicant will have the same total number of responses/answers, which corresponds to the number of reference providers for the applicant. As the reference provider's answer to each question may differ, the frequency for each answer of each question may differ.

Compute module 4500 may be configured to generate a suitability score based on the applicant reference data and the team reference data. Suitability score indicates the suitability of the applicant for the team. Suitability score may be also known as a team-fit score and as the name suggests, the suitability score can be used to sift out applicants possessing the best “culture-fit” with the team. It indicates how the close the behavioural traits of the applicant is and the team. Compute module may be configured to generate the suitability score based on the applicant reference data and the team convergence score.

Recruiter may measure the closeness of fit of the reference response, in comparison with model answers, i.e. ideal answer determined by the recruiter. Method 100 may be configured to measure the frequency that the reference provider responses to a question matches the model answers. As such, the multiple choice question may work better for the computation of the comparison.

For consistency, the recruiter should forward the same reference form, i.e. with the same plurality of questions, via the applicant to the reference provider for the evaluating the suitability of an applicant for a team to all the reference provider nominated by the applicant. Reference form may be in the form of a link whereby the recruiter transmit the link to the reference provider via the applicant.

When using the method 100 of the present invention to assess competency of an applicant, the recruiter may obtain more revealing information about the applicant, based on third party reference provider's assessment, rather than based on the applicant's self-evaluation.

Server 210 may include a matching module configured to match the applicant reference data to the team reference data to generate a matching score. Method 100 may include matching the applicant reference data to the team reference data to generate a matching score. Matching score indicates the degree of match between the applicant reference data and the team reference data. Recruiter may use the matching score to evaluate how similar is the applicant reference data to the team reference data.

A team response score may be generated for each answer of each of the plurality of questions. Team response score may be an average score generated by averaging across all the team members for each answer. Server 210 may generate the team response score based on the applicant reference data and the team reference data to produce the suitability score.

Recruiter may add a weight factor to the questions that are most relevant to the assessment of the applicant. Reference form module 4200 may be configured to accept a number of questions which corresponds to the weight placed on the question. For example, 5 questions for weight of 5, 1 question for weight of 1. Referring to FIGS. 8a and 8b, the skill for automated external defibrillation, sterilise equipment, perform health assessment, perform enteral tube feeding, and manage controlled drugs have one question each. This is in line with their weight placed for the related questions for the job scope of the applicant, e.g. a nurse.

The skill of monitor vital signs is very deemed the most important for the job scope of the applicant and therefore carries a weight of five. Hence, five questions in the reference form are related to the skill. The skill of oropharyngeal airway is ranked the second most important for the job scope of the applicant. As it carries a weight of two, two questions are allocated for the skill of oropharyngeal airway.

In assessing behavioural qualities, the method may be configured to measure the closeness of fit between the applicant's reference data and the team reference data. Recruiter may find the weighted score for each answer to each question for each team member, based on reference responses of the team member.

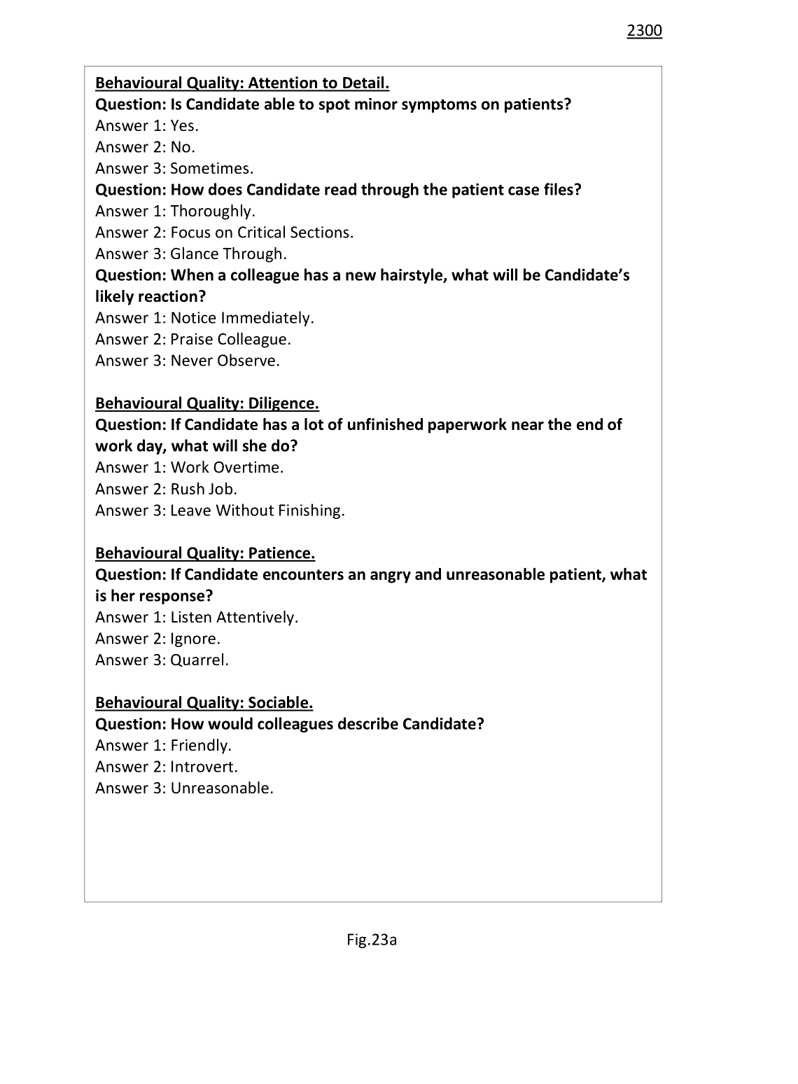

Server 210 may include the compute module 4500. Compute module may include an applicant reference normalising module configured to normalise the at least one applicant reference response. Server 210 may include a team member reference normalising module configured to normalise the one or more team member reference data. FIG. 22 shows an exemplary flow diagram 4520 of a process carried out by the compute module 4500. As shown in FIG. 22, the method 100 may include normalising the at least one applicant reference response in 4522. Further, the method 100 may include normalising the at least one team member reference data in 4524. When one or more reference responses is received by the recruiter from the reference provider/s, the one or more reference responses may be normalised so that the received reference response/s may be compared on a common basis. A response for each of the plurality of questions in the plurality of reference response may be normalised to obtain a normalised applicant or team member reference data. When a recruiter wishes to evaluate the suitability of the applicant for a team, the same reference form may be forwarded to the applicant and the team members so that the reference response received for the applicant and team members may be assessed on the same basis. Plurality of questions relevant to the team member may be the same as the plurality of questions relevant to the applicant. As the reference responses may be vary from each other, normalising the reference response/s allows the reference response to be compared on the same basis or common scale. Thereafter, the applicant reference data may be generated based on the normalised reference response/s for the applicant. Team member reference data may be generated based on the normalised reference response/s for each of the team member. Compute module 4500 may compute the team convergence score in 4526 and the suitability score 4528 as mentioned earlier.

Server 210 may include a plurality of language modules configured to display the user interfaces in a chosen language. A user interface may be a webpage, a mobile application, etc.

In the following example, a case for recruiting an applicant, e.g. a nurse, for a team, e.g. a medical team, is presented. Recruiter may wish to evaluate the suitability of the applicant to the team, which may include a doctor, a few nurses, etc. While a medical team is used in this example, it is understood that other teams may be used in place of the medical team. For example, project team, design team.

For the applicant's position, the recruiter may be interested to know about the following skill set of the applicant: manage surgical hygiene; sterilise equipment; perform health assessment; monitor vital signs; perform enteral tube feeding; insert oropharyngeal airway; manage controlled drugs.

Recruiter may rank and add weights to identify the importance of each skill in the skill set. For example:

| Skillset | Weight |
|---|---|
| Automated external defibrillation | 1 |
| Sterilise equipment. | 1 |
| Perform health assessment. | 1 |
| Monitor vital signs. | 5 |
| Perform enteral tube feeding. | 1 |
| Oropharyngeal airway. | 2 |
| Manage controlled drugs. | 1 |
| Total | 12 |

Recruiter may increase the number of questions for each skill according to the weight placed on the skill. For example, 5 questions for weight of 5, 12 questions for weight of 12. Compute module 4500 may include a scoring module configured to calculate a skill score for each skill based on the weight and/or rank of the skill. An example of the above is shown in FIGS. 8a and 8b.

To create a reference form for evaluating the applicant, the recruiter may start by listing a job scope for a vacant position. In crafting the job scope, the recruiter may review the organization's operating manuals, refer to previous job advertisements, as well as consult the manager/superior/existing staff/previous staff of the post. The job scope should reflect the daily operational tasks, the weekly/monthly duties, the quarterly targets, wider responsibilities to the colleagues/superiors/customers, etc.

Next, the recruiter may draw out an interactions map for the position. Interaction map includes the interactions between the team members who any successful applicant would have to interact. Team members may include colleagues, subordinates, superiors, customers, patients, public, stakeholders, etc. Recruiter may consider how often the successful applicant would have to interact with these team member and how important are each of these interactions or relationships.

Recruiter may draft a list of behavioural qualities that are critical or useful for the role. From the recruitment example (of the nurse), the recruiter may have listed down the following personal qualities for the role: attention to detail, diligence, patience, sociable, able to handle emergencies. From the above list of behavioural qualities, some qualities may be more critical for the applicant to perform the job properly and some qualities may be useful for the applicant to perform better, but may not be critical.

Hence, the recruiter may rank and add weight to the importance of each behavioural quality. In considering the behavioural weighting, the recruiter may consider the following: How would the behavioural quality influence the applicant's performance? How would the behavioural quality influence the applicant's interactions with stakeholders (e.g. colleagues, subordinates, superiors, customers, patients, public, etc.)? What can the applicant achieve if the applicant has the behavioural quality? What may happen if the applicant does not possess the behavioural quality? Does this behavioural quality enhance the performance of the team?

After careful consideration, the recruiter may assign the following behavioural weightings for the role of the applicant:

| Behavioural Quality | Weight |
|---|---|
| Attention to Detail | 3 |
| Diligence | 1 |
| Patience | 1 |
| Sociable | 1 |
| Able to Handle Emergencies | 4 |
| Total | 10 |

Recruiter may want to increase the weightage of a behavioural quality in the evaluation by creating more questions testing that behaviour in the reference form. In this way, the method may score the applicant with an important behavioural quality higher.

In the recruitment example, the combined weighting score of all the behavioural qualities is ten. The ability to handle emergencies is the most important behavioural quality for the job. Hence, it is given the highest weight of four out of ten.

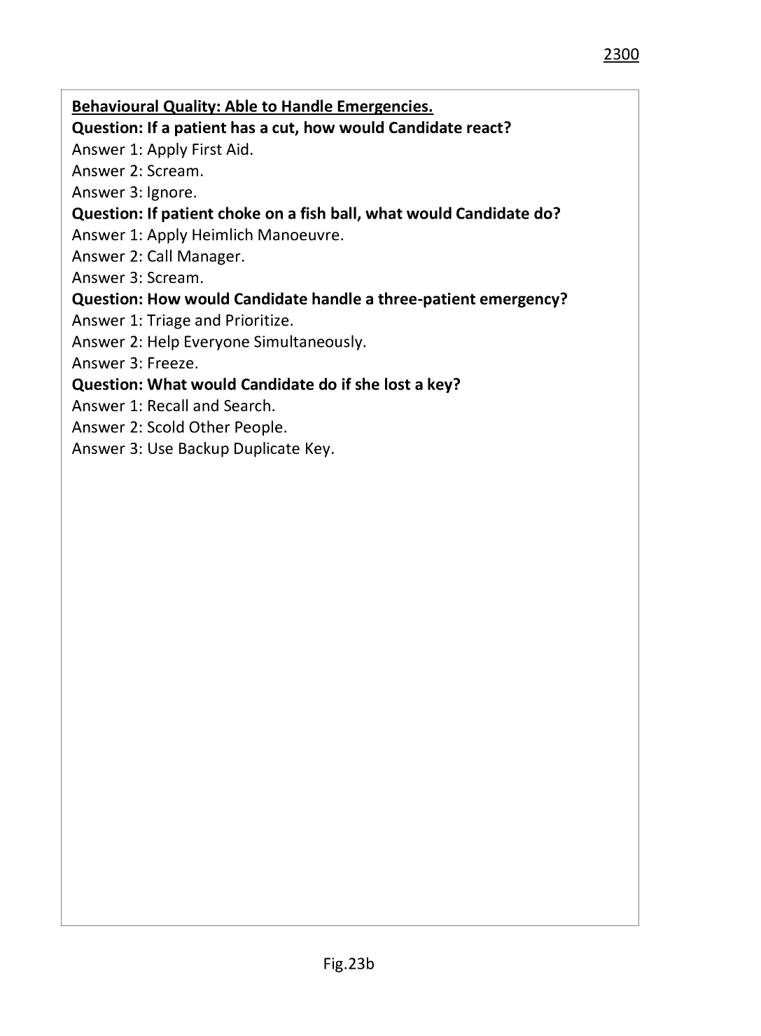

Attention to detail is the next important quality, so it is given a weighting of three out of ten. FIGS. 23a and 23b show an example of the questions for the reference form 2300.

In the reference form, the behavioural qualities of diligence, patience and sociable are allocated one question each. This is because each of these qualities are weighted one out of ten. The behavioural quality of being able to handle emergencies is deemed most important for the recruitment of the applicant, e.g. a nurse. As such, there are four questions in the reference form as shown in FIG. 23a and 23b, in line with its four out of ten rating. Meanwhile, the attentiveness to detail is the second most important behavioural quality and therefore has a weight of three out of ten. Hence, it has three questions in the reference form as shown in FIGS. 23a and 23b, out of a total of ten questions.

Recruiter may select a plurality of questions from the question database 234 for the reference form. Recruiter may search for questions from the question database 234. In the event that the questions in the question database 234 are not suitable, the recruiter may create questions using the question module 4100. Recruiter may create the questions in at least one language, e.g. English and Chinese. Recruiter may also edit the questions in the question database 234 so as to customise the questions to be suitable for the applicant position, e.g. nursing.

Thereafter, the recruiter may create a reference form that is relevant to the needs of the team, e.g. medical team. In creating the reference form, the recruiter may select a plurality of questions from the question database 234. Recruiter may select a reference form from the reference form database 236. Recruiter may edit a reference form selected from the reference form database 236. Recruiter may sort the question in a preferred order. In a behavioural-focused question, the recruiter may re-arrange the sequences of the optional answers to each question so as to ensure that there is no discernible patterns to the optional answers for each of the plurality of questions. At this stage, the recruiter would have completed the reference form for the evaluation.

In order to evaluate the suitability of the applicant, i.e. nurse, for the team, i.e. medical team, the recruiter would require a team reference data of the team. If the recruiter does not have the team reference data of the team, the recruiter may have to obtain reference response for each of the team member of the team in order to obtain the team reference data. To create the team, the recruiter may input the email address of each of the team member into the team user interface 4360. If the recruiter does not have the reference response for any of the team members, the recruiter may forward the reference form to each of the team member via their email address so that the each of the team member may forward the reference form to their reference providers for their completion.

Upon receipt of the reference responses from the reference providers, the recruiter may compute a team convergence score to determine a similarity level of the team members within the team.

To evaluate the suitability of the applicant for the team, the applicant would have to join the team for the recruiter to compute the suitability score. At this juncture, it would be good to clarify that joining the team does not mean that the recruiter has “hired” the applicant to be part of the team but only to join the team for the purpose of evaluating the suitability of the applicant for the team. To join the team, the recruiter may send the notification 1400 to the applicant for the applicant to acknowledge and agree to join the evaluation. Applicant may agree to join the evaluation by clicking the acknowledgement module 1410 on the notification 1400. Upon joining the evaluation, the status of the applicant may be changed from “Pending” to “Joined”.

Recruiter may send the reference form to the applicant. Thereafter, the applicant may forward the reference form to the reference provider of the applicant. Recruiter may send an email or short message having a link to the reference form. Applicant may activate the reference provider by forwarding the activation notification 1750 to the reference provider so as to allow the reference provider to participate as a reference provider. Applicant may forward the email or short message to the reference provider. Reference provider may click on the link to assess the reference form. Reference provider may complete the reference form and return the reference form to the recruiter. Reference provider may complete the reference form and save the reference response directly back to the reference response database 237. As such, the recruiter may obtain reference response for the applicant from the response database. In addition, recruiter may require a certain relationship category between the reference provider and the applicant. Server 210 may authenticate the reference response before storing the reference response by verifying the authentication data, e.g. email address, phone number, on the reference form with the data of the reference provider provided by the applicant.

Each team member or applicant may have more than one reference provider such that each team member or applicant may have more than one reference response.

Recruiter may generate a team member reference data based on the reference response of the team member. Recruiter may generate a team reference data based on the team member reference data of the team members. Recruiter may generate the applicant reference data based on at least one applicant reference response of the applicant. Server 210 may normalise each of the team member reference data before generating the team reference data. Server 210 may normalise the applicant reference response before generating the applicant reference data.

Recruiter may create a project for the evaluation. Recruiter may select a project from a list of projects in the project database 238. Recruiter may search for a project via the project title or the project description. Based on the applicant reference data and the team reference data, the recruiter may generate the suitability score to evaluate the suitability of the applicant for the team. When the reference response data for an applicant is closest to the team reference data, the applicant may then be considered to be a closest fit to the team.

Recruiters may use the method 100 to identify from among the new team members, the one with the best potential for development. This enables organizations to focus time, training, resources and opportunities on employees who are likely able to contribute more to the organization. Method 100 can “learn” from the organizations' past experience with its managers to identify the new team members with the best potential.

Method 100 may be used to “learn” about an organization's culture based on the reference records for the team members. Over time, the method 100 would be able to collate a substantial number of reference response of the team members and applicants.

Method 100 may include learning modules to “learn” about the qualities of team members who would perform well in the organization. Over time, the recruiters would also be able to make use of the databases to better identify applicants with good cultural fit with the organization.

Upon identifying the right applicant, the recruiter may then arrange for an interview with the selected applicant. In this way, the recruiter would be able to shorten the process and lower the time and costs in hiring team members.

Alternatively, the recruiter may arrange for an interview with the applicant before evaluating their suitability. However, the latter arrangement would cost the recruiter more time and resources.

Method 100 may be configured to identify an applicant or team member who has a diverse character from the team. When a recruiter plans to gather a team with diverse characters, the recruiter may want to identify an applicant or team member who is different from the team. Recruiter may select an applicant or team member who has the lowest suitability score. Such applicants/team members may provide opinions and perspectives different from the other team members. Recruiters may use non-ipsative questions to better identify outlier applicants/team members.

Server 210 may be configured to identify an applicant who is not suitable for the team by evaluating the applicant's reference data against the reference data of applicants who were not hired by the team. Server 210 may include an unsuccessful applicant database which stores the reference data of unsuccessful applicants. Based on the reference data, the recruiter may compile a group reference data based on the unsuccessful applicants' reference data. Recruiter may compare an applicant reference data with the group reference data to generate a suitability score. A high suitability score against the group reference data may indicate that the applicant may not be suitable for the team.

1. A computer-implemented method for evaluating the suitability of an applicant for a team having at least one team member, the method comprising:
generating a team reference data of the team based on at least one team member reference response, each from a team member's reference provider, wherein the team member reference response comprises a response to a plurality of questions relevant to the at least one team member;
receiving an applicant reference response from at least one reference provider, wherein the applicant reference response comprises a response from the at least one reference provider to a plurality of questions relevant to the applicant;
generating an applicant reference data based on at least one of the applicant reference response; and
generating a suitability score based on the applicant reference data and the team reference data, wherein the suitability score indicates the suitability of the applicant for the team.

2. The method of claim 1, further comprising generating a team member reference data for each of the at least one team member based on one or more team member reference response, wherein the team reference data is generated based on one or more team member reference data.

3. The method of claim 2, further comprising normalising the one or more team member reference data.

4. The method of claim 1, further comprising normalising the at least one applicant reference data.

5. The method of claim 1, wherein the applicant reference response comprises an array of applicant response data, wherein the applicant reference data comprises an array of normalised scores which corresponds to the array of applicant response data.

6. The method of claim 1, wherein the team member reference response comprises an array of team member response data, wherein the team reference data comprises an array of normalised scores which corresponds to the array of team member response data.

7. The method of claim 1, further comprising matching the applicant reference data to the team reference data to generate a matching score, wherein the matching score indicates the degree of match between the applicant reference data and the team reference data.

8. The method of claim 1, further comprising computing a team convergence score based on the team reference data, wherein the team convergence score indicates a similarity level between team members in the team.

9. The method of claim 1, wherein the plurality of questions include selected questions relevant to the team.

10. The method of claim 1, wherein the plurality of questions include at least one ipsative question.

11. A computer system for evaluating the suitability of an applicant for a team having at least one team member, the system comprising:
a server configured to:
generate a team reference data based on at least one team member reference response, each from a team member's reference provider, wherein the team member reference response comprises a response to a plurality of questions relevant to the at least one team member;
receive an applicant reference response from at least one reference provider, wherein the applicant reference response comprises a response from the at least one reference provider to a plurality of questions relevant to the applicant;
generate an applicant reference data based on at least one of the reference response; and
generate a suitability score based on the applicant reference data and the team reference data, wherein the suitability score indicates the suitability of the applicant for the team.

12. The system of claim 11, wherein the server is configured to generate a team member reference data for each of the at least one team member based on one or more team member reference response, wherein the team reference data is generated based on one or more team member reference data.

13. The method of claim 12, further comprising a team member reference normalising module configured to normalise the one or more team member reference data.

14. The method of claim 11, further comprising an applicant reference normalising module configured to normalise the at least one applicant reference data.

15. The method of claim 11, wherein the applicant reference response comprises an array of applicant response data, wherein the applicant reference data comprises an array of normalised scores which corresponds to the array of applicant response data.

16. The method of claim 11, wherein the team member reference response comprises an array of team member response data, wherein the team reference data comprises an array of normalised scores which corresponds to the array of team member response data.

17. The method of claim 11, further comprising a matching module configured to match the applicant reference data to the team reference data to generate a matching score, wherein the matching score indicates the degree of match between the applicant reference data and the team reference data.

18. The method of claim 11, further comprising a computing module configured to compute a team convergence score based on the team reference data, wherein the team convergence score indicates a similarity level between team members in the team.

19. The method of claim 11, wherein the plurality of questions include selected questions relevant to the team.

20. The method of claim 11, wherein the plurality of questions include at least one ipsative question.
